(19) United States
(12) Patent Application Publication
(10) Pub. No.: US 2026/0205365 A1
(43) Pub. Date: Jul. 16, 2026

(54) METHOD FOR DEPLOYING SFC IN MULTI-DOMAIN NETWORK BASED ON VNF DEPENDENCY COMPONENT MIGRATION

(71) Applicant: Nanjing University of Aeronautics and Astronautics, Jiangsu (CN)

(72) Inventors: Ran WANG, Jiangsu (CN); Yuhan ZHANG, Jiangsu (CN); Qiang WU, Jiangsu (CN); Jie Hao, Jiangsu (CN)

(73) Assignee: Nanjing University of Aeronautics and Astronautics, Jiangsu (CN)

(21) Appl. No.: 19/224,886

(22) Filed: Jun. 1, 2025

(30) Foreign Application Priority Data
Jan. 16, 2025 (CN) 202510067794.1

(51) Int. Cl. H04L 41/122; H04L 41/0226; H04L 41/0895; H04L 43/20

(52) U.S. Cl. CPC H04L 41/122; H04L 41/0226; H04L 41/0895; H04L 43/20

(57) ABSTRACT

The present disclosure discloses a method for SFC deployment based on VNF-dependent software migration in a multi-domain network, and relates to the field of communications technologies. The method jointly optimizes the SFC deployment and the migration of VNF-dependent software to resolve issues concerning service provision in the multi-domain network. According to the method, information related to the multi-domain network is first initialized, and then a multi-layer network architecture is constructed to support SFC deployment. Then, a multi-layer weighted network is established by using an analytic hierarchy process (AHP), and an SFC deployment policy and a VNF-dependent software migration policy are executed on this basis. In the present disclosure, the impact between SFC deployment and VNF-dependent software migration decisions is comprehensively considered, achieving efficient SFC deployment and VNF-dependent software migration in the multi-domain network.

### CROSS-REFERENCE TO RELATED APPLICATION

This application claims the priority benefit of China application serial no. 202510067794.1, filed on Jan. 16, 2025. The entirety of the above-mentioned patent application is hereby incorporated by reference herein and made a part of this specification.

### TECHNICAL FIELD

The present disclosure relates to network communications technologies, and specifically, to a method for service function chain (SFC) deployment based on virtualized network function (VNF)-dependent software migration in a multi-domain network.

### DESCRIPTION OF RELATED ART

SFC deployment is an emerging research subject in the service delivery field. Related research may be classified into two types: SFC deployment in a single domain and SFC deployment across multiple domains.

When SFC is deployed in a single-domain network, some research has delved into VNF placement, resource allocation optimization, and network throughput improvement to effectively reduce service costs. However, the end-to-end latency, a key performance indicator, is ignored, while the latency is crucial to ensuring overall network performance. Some researchers have devoted themselves to ensuring the quality of service by reducing the end-to-end latency of SFC. Meanwhile, some research focuses on jointly optimizing cost and latency, and has proposed a method for SFC deployment based on integer linear programming (ILP), deep reinforcement learning (DRL), and heuristics. However, it is difficult for an SFC deployment policy in a single-domain network to support SFC deployment in a cross-domain network. In addition, 6G's support for vertical services and applications highlights the critical demand for cross-domain service provision. Since 2017, researchers in the field of network communications have discussed service provision in a multi-domain network, including new architectures and new methods for SFC deployment in a multi-domain network, aiming to minimize the consumption cost of network resources, reduce the SFC communication latency, and achieve load balancing of the multi-domain network.

However, solving the problem regarding achieving optimal SFC deployment in a multi-domain network to ensure cost-effective and low-latency service delivery is not an easy task. In addition, previous research neglects the dependent software required for VNF execution. It is assumed that a physical node can independently execute all VNFs. However, network function instantiation requires the physical node to have corresponding software resources to support the operation of the network function, including system-level software resources (for example, Ubuntu, VEKET, and CentOS), configuration files (for example, network interface files and routing rule configuration files), and application-level software resources (for example, IPFilter and Hash Switch). Referred to as VNF-dependent software, the resource software supports and is crucial to the operation of the VNE.

In a large-scale multi-domain 6G network, network heterogeneity between domains is increasingly pronounced, and different domains have differentiated VNF placement platforms. To meet time-varying extreme service demands and improve platform competitiveness, the VNF platform needs to be frequently upgraded and additional configurations, such as network interface settings and routing configuration adjustments, need to be performed to ensure the seamless operation of the VNF and reliable network communication. Although virtual machine and container technologies reduce the operational and management costs for service providers, they also introduce relatively high latencies. Compared to virtual machines, containers reduce communication latency by sharing an operating system, but typically start slowly. Martines et al. have proposed a lightweight virtual machine platform based on the Xen hypervisor, which defines and executes a VNF by using a Click modular router. This method enables the VNF to operate as a modular Click configuration, thereby significantly reducing the overheads of network function virtualization. Similar to the ClickOS, the Click-on-OSv provides a lightweight and low-latency solution, and is applicable to a network function that has a high performance requirement. In addition, considering that the VNF-dependent software may accelerate the update speed of the VNF, the flexible placement of the VNF-dependent software in a large-scale multi-domain heterogeneous 6G network and efficient adaptation to evolving service demands need to be enhanced. This method is also closely aligned with the 6G vision and supports the ultra-low latency application.

### SUMMARY

Objective: To minimize communication latency and service provision costs, ensure load balancing of the multi-domain network, meet extreme service demands, and provide high-performance communication services, the present disclosure provides a method for SFC deployment based on VNF-dependent software migration in a multi-domain network.

Technical solutions: The present disclosure provides a method for SFC deployment based on VNF-dependent software migration in a multi-domain network. The method includes:

(1) constructing a multi-domain network communication architecture based on a software-defined networking (SDN) controller, where the multi-domain network communication architecture includes a multi-domain physical network, a terminal user, a domain-specific SDN controller, and a central SDN controller; the terminal user initiates a service request to the domain-specific controller; the domain-specific SDN controller transmits information to the central SDN controller; the central SDN controller issues an SFC deployment instruction and a VNF-dependent software migration instruction to the domain-specific SDN controller in conjunction with VNF-dependent software migration; and a multi-domain network provides services for the terminal user according to a decision of the domain-specific SDN controller;

(2) establishing a network topology and a service request model, which specifically includes:
(21) mapping a service function chain through a heterogeneous multi-domain physical network based on a multi-domain network topology, where
a domain set of the heterogeneous multi-domain physical network is represented as [symbol] ={G₁, G₂, . . . , Gᵣ, . . . , G_{|G|}}, where Gᵣ represents a τ-th network domain, |G| represents a number of domains, a multi-domain physical network node set is represented as N_{τ}={n_{τ1}, n_{τ2}, . . . , n_{τi}, . . . n_{τ|N}_{_{τ}}_{|}}, n_{τi} represents a i-th node in the network domain τ, a physical network link set is represented as E_{τ}={e_{τi, τj}|n_{τi}, n_{τj}∈N_{τ}}, the multi-domain network supports |K| types of VNFs and operates for a long period of time T={1, 2, . . . , t, . . . , |T|} to support provision of services requested by the user, and a node set N is used for deploying virtual machines to operate VNFs and forward data; a maximum computing capability

$${ϕ}_{{n}_{τ i}}^{c} ,$$

a maximum memory capacity

$${ϕ}_{{n}_{τ i}}^{m} ,$$

and a maximum storage capacity

$${ϕ}_{{n}_{τ i}}^{s}$$

of each server node are used to represent computing, memory, and storage resources of the node, respectively, and each server node belongs to one sub-network; a variable Oₙ_{_{τi}} is defined to represent a domain to which a server node n_{τi} belongs, a link e_{τi, \hat{τ}j} connects two server nodes n_{τi} and n_{τj}, representing a physical link therebetween; when τ is equal to \hat{τ}, the connection represents an intra-domain link, and otherwise, represents an inter-domain link; nₑ_{_{τi,\hat{τ}j}},1 and nₑ_{_{τi,\hat{τ}j}},2 represent a starting node and an ending node of the link e_{τi, \hat{τ}j}, respectively; and b_{eτi, \hat{τ}j} is used to represent a bandwidth capacity of the link e_{τi, \hat{τ}j},

$${\hat{ϕ}}_{{n}_{τ i}}^{c}$$

is used to represent remaining computing resources of the server node n_{τi},

$${\hat{ϕ}}_{{n}_{τ i}}^{m}$$

represents remaining memory resources of the server node n_{τi},

$${\hat{ϕ}}_{{n}_{τ i}}^{s}$$

is used to represent remaining storage resources of the service node n_{τi}, and \hat{b}ₑ_{_{τi,\hat{τ}j}} represents remaining bandwidth resources of the link e_{τi,\hat{τ}j};

(22) constructing the service request model, where
all user requests that enter a network function virtualization (NFV)-based multi-domain network and have actual demands are represented as SFC requests, an SFC request set is represented as Γ={Γ₁, Γ₂, . . . , Γᵣ, . . . , Γ_{|Γ|}}, and a 5-tuple {sᵣ, dᵣ, bᵣ, l̅ᵣ, Gᵣ} is defined to represent an SFC request r, where sᵣ,dᵣ represent a source node and a target node, respectively, and each SFC request r has a known bandwidth demand bᵣ and a maximum tolerable end-to-end latency requirement l̅ᵣ; and
the SFC request r consists of a group of predefined VNFs and links, and is represented as a directed weighted graph Gᵣ={Fᵣ,Eᵣ}, where Fᵣ={ƒᵣ₁, ƒᵣ₂, . . . , ƒᵣₕ, . . . , ƒ_{r|F}_{ᵣ}_{|}} represents a set of VNFs and Eᵣ={ξƒ_{rg},ƒᵣₕ|ƒ_{rg},ƒᵣₕ∈Nᵣ} represents a set of virtual network links; and each VNF ƒᵣₕ∈Fᵣ requires a certain amount of server computing resources

$${\hat{R}}_{{f}_{rh}}^{c}$$

and a certain amount of memory resources

$${R}_{{f}_{rh}}^{m} ,$$

and similarly, bandwidth resources bᵣ need to be allocated for mapping a virtual link;

(23) constructing a VNF-dependent software migration model, configured to migrate software from one server node to another server node, where
when a virtual network function ƒᵣₕ is decided to be deployed on the server node n_{τi} with insufficient software resources, related dependent software of ƒᵣₕ is migrated to the node n_{τi}; and Ψ={Ψ₁, Ψ₂, . . . , Ψ_{q}, . . . , Ψ_{|Ψ|}} represents a set of all software resources supporting operation of the VNF; and
for VNF placement and logical link mapping, two binary decision variables are used to define this relationship:

$${x}_{{f}_{rh}}^{{n}_{τ i}} = \{ \begin{matrix}1 , & {f}_{rh} is placed on node {n}_{τ i} , \\ 0 , & otherwise\end{matrix} . \qquad ( 1 )$$

$${y}_{{ξ}_{{f}_{rg} , {f}_{rh}}}^{{e}_{τ i , \hat{τ} j}} = \{ \begin{matrix}1 , & {ξ}_{{f}_{rg} , {f}_{rh}} is mapped on link {n}_{τ i , \hat{τ} j} , \\ 0 , & otherwise\end{matrix} . \qquad ( 2 )$$

where a logical link ξ_{ƒrg,ƒrh} is able to be mapped to a plurality of physical links, indicating that communication between VNFs is able to span a plurality of physical connections; and

(24) a VNF-dependent software migration decision
where an operating time period of the NFV-based multi-domain network is equally divided into several time slots; it is assumed that new SFC request information is collected in a time slot t−1, an SFC is deployed in a time slot t, and meanwhile, migration of resources of software Ψ_{q} is executed and completed in the time slot t; one binary variable

$${Y}_{{n}_{τ i}}^{{f}_{rh}} ( t )$$

is defined to indicate whether the server node n_{τi} supports the VNF ƒᵣₕ in the time slot t; and

$${χ}_{{ψ}_{q}}^{{n}_{τ i}} ( t )$$

is a binary migration decision variable indicating whether the software Ψ_{q} is migrated for the node n_{τi} within the time slot t, where

$${Y}_{{n}_{τ i}}^{{f}_{rh}} ( t ) = {\prod }_{{ψ}_{q} ∈ {Ψ}_{r h}} c \cdot ResourceConstraint , \qquad ( 3 )$$

$${Z}_{{n}_{τ i}}^{{ψ}_{q}} ( t )$$

is a binary variable indicating whether the software Ψ_{q} is on the server node n_{τi} in the time slot t; Ψᵣₕ is a dependent software set supporting operation of the virtual network function ƒᵣₕ; and ResourceConstraint is an indication variable indicating whether other resources on the service node n_{τi} are sufficient to support operation of the virtual network function ƒᵣₕ, where when the resources on the service node n_{τi} are sufficient, a value of the indication variable is 1, and a corresponding mathematical expression is:

$${χ}_{{ψ}_{q}}^{{n}_{τ i}} ( t ) = [ 1 - {Z}_{{n}_{τ i}}^{{ψ}_{q}} ( t - 1 ) ] \cdot [ {Z}_{{n}_{τ i}}^{{ψ}_{q}} ( t - 1 ) ⊕ {Z}_{{n}_{τ i}}^{{ψ}_{q}} ( t ) ] , \qquad ( 4 )$$

where when

$${χ}_{{ψ}_{q}}^{{n}_{τ i}} ( t ) = 1 ,$$

it indicates that the software Ψ_{q} has been migrated to the server node n_{τi} in the time slot t, and otherwise, it indicates that the software Ψ_{q} has not been migrated;

$${Ψ}_{{f}_{rh}}^{mig}$$

is used to represent a software resource set that needs to be migrated for the VNF ƒᵣₕ; and after software that needs to be migrated is determined, software resources on a corresponding node are updated;

(3) formulating problems to be solved and determining an optimization objective based on the network topology and the service request model constructed in step (2), where
the problems to be solved are defined as follows:
an SFC deployment problem, where given a domain set [symbol] of a network and an SFC request set Γ, a routing path of an SFC and a deployment policy thereof are determined, and quality of the selected path is considered to minimize an SFC placement cost and ensure an end-to-end latency of the SFC while a constraint of physical network resources is satisfied; and
a VNF-dependent software migration problem, where based on the given domain set [symbol] of the network, an SFC deployment result, and a distribution matrix Z of current software resources, a migration policy of software and a migration path thereof are determined; and considering a VNF's demand for dependent software, when a selected server node is unable to provide sufficient software resources, a migration cost is minimized; and
an overall optimization objective is determined based on multi-domain network information, user terminal service request information, and the VNF-dependent software migration model, where the overall optimization objective is to minimize the end-to-end latency of all SFCs and costs related to SFC deployment and VNF-dependent software, that is, a VNF-dependent software migration cost and a VNF-dependent software placement cost, where an end-to-end latency of the SFC request is defined as a sum of link latencies Dᵣ, with a mathematical expression as follows:

$${D}_{r} = {\sum }_{{ξ}_{{f}_{rg} , {f}_{rh}} ∈ {E}_{r}} {\sum }_{{e}_{τ i , \hat{τ} j} ∈ E} {y}_{{ξ}_{{f}_{rg} , {f}_{rh}}}^{{e}_{τ i , \hat{τ} j}} \cdot {l}_{{e}_{τ i , \hat{τ} j}} + {\sum }_{{f}_{rh} ∈ {F}_{r}} {\sum }_{{n}_{τ i} ∈ N} {x}_{{f}_{rh}}^{{n}_{τ i}} \cdot {l}_{{n}_{τ i}} \qquad ( 5 )$$

where lₑ_{_{τi,\hat{τ}j}} is a latency on a link e_{τi,\hat{τ}j}, and lₙ_{_{τi}} is a processing latency on the serving node n_{τi};
a placement cost of the SFC request r is defined as

$${C}_{r}^{d} ,$$

and a total placement cost of the SFC request r is represented by

$${C}_{r}^{s} ,$$

where

$${C}_{r}^{d}$$

consists of node resource usage costs, with the following expression:

$${C}_{r}^{d} = {\sum }_{{f}_{rh} ∈ {F}_{r}} {\sum }_{{n}_{τ i} ∈ N} {x}_{{f}_{r h}}^{{n}_{τ i}} \cdot ( {c}_{{n}_{τ i}}^{C P U} \cdot {R}_{{f}_{r h}}^{c} + {c}_{{n}_{τ i}}^{m e m} \cdot {R}_{{f}_{r h}}^{m} ) \qquad ( 6 )$$

and

$${C}_{r}^{s}$$

consists of the VNF-dependent software migration cost and the VNF-dependent software placement cost, and is defined as follows:

$${C}_{r}^{s} = {\sum }_{{f}_{rh} ∈ {F}_{r}} {\sum }_{{ψ}_{q} ∈ {Ψ}_{{f}_{rh}}^{mig}} {\sum }_{{p}_{τ i , \hat{τ} j} ∈ {L}_{{Ψ}_{q}}} {y}_{{p}_{τ i , \hat{τ} j}}^{{e}_{τ i , \hat{τ} j}} \cdot {l}_{{e}_{τ i , \hat{τ} j}} + {\sum }_{{f}_{rh} ∈ {F}_{r}} {\sum }_{{ψ}_{q} ∈ {Ψ}_{{f}_{rh}}^{mig}} {x}_{{f}_{r h}}^{{n}_{τ i}} \cdot {χ}_{{ψ}_{q}}^{{n}_{τ i}} \cdot {c}_{{n}_{τ i}}^{s t o} \cdot {R}_{{ψ}_{q}}^{s} \qquad ( 7 )$$

a service delivery cost Cᵣ of the SFC request r is defined as follows:

$${C}_{r} = {C}_{r}^{d} + {C}_{r}^{s} \qquad ( 8 )$$

and a joint optimization objective is expressed as follows:

$$min {\sum }_{{Γ}_{r} ∈ Γ} {ω}_{1} {D}_{r} + {ω}_{2} {C}_{r} \qquad ( 9 )$$

where ω₁ and ω₂ are adjustable weight factors for balance each objective; by adjusting a weight factor of each objective, a preference of a specific objective is highlighted, and constraint conditions of physical network resources and quality of service of the SFC are satisfied, where
constraint conditions (10) and (11) ensure that on any server node n_{τi}, total central processing unit (CPU) and memory resource demands required for SFC deployment are restricted to respective maximum CPU and memory resource capacities:

$${\sum }_{{Γ}_{r} ∈ Γ} {\sum }_{{f}_{r h} ∈ {F}_{r}} {x}_{{f}_{r h}}^{{n}_{τ i}} \cdot {R}_{{f}_{r h}}^{c} \leq {ϕ}_{{n}_{τ i}}^{c} , ∀ {n}_{τ i} ∈ N , \qquad ( 10 )$$

$${\sum }_{{Γ}_{r} ∈ Γ} {\sum }_{{f}_{r h} ∈ {F}_{r}} {x}_{{f}_{r h}}^{{n}_{τ i}} \cdot {R}_{{f}_{r h}}^{m} \leq {ϕ}_{{n}_{τ i}}^{m} , ∀ {n}_{τ i} ∈ N . \qquad ( 11 )$$

a constraint condition (12) ensures that used storage resources shall not exceed a maximum storage resource capacity:

$${\sum }_{{ψ}_{q} ∈ {Ψ}_{{n}_{τ i}}} {Z}_{{n}_{τ i}}^{{ψ}_{q}} \cdot {R}_{{ψ}_{q}}^{s} \leq {ϕ}_{{n}_{τ , i}}^{s} , ∀ {n}_{τ i} ∈ N , \qquad ( 12 )$$

where Ψₙ_{_{τi}}, is a software set on the node n_{τi}; and similarly, total bandwidth consumption on any link e_{τi,\hat{τ}j} must be less than a maximum bandwidth capacity, with the following constraint condition:

$${\sum }_{{Γ}_{r} ∈ Γ} {\sum }_{{ξ}_{{f}_{rg} , {f}_{rh}} ∈ {E}_{r}} {y}_{{ξ}_{{f}_{rg} , {f}_{rh}}}^{{e}_{τ i , \hat{τ} j}} \cdot {b}_{r} \leq {b}_{{e}_{τ i , \hat{τ} j}} , ∀ {e}_{τ i , \hat{τ} j} ∈ E . \qquad ( 13 )$$

to satisfy the quality of service, a latency constraint (14) ensures that the end-to-end latency of any SFC^{r} must be satisfied, with the following constraint condition:

$${D}_{r} \leq \overline{{l}_{r}} , ∀ {Γ}_{r} ∈ Γ . \qquad ( 14 )$$

and a constraint (15) ensures that each ƒᵣₕ can be successfully deployed on only one server node at most, which means that a VNF instance is inseparable, and corresponds to:

$${\sum }_{{n}_{τ i} ∈ N} {x}_{{f}_{r h}}^{{n}_{τ i}} \leq 1 , ∀ {Γ}_{r} ∈ Γ , ∀ {f}_{r h} ∈ {F}_{r} . \qquad ( 15 )$$

where to simplify SFC deployment, it is assumed that an ingress node of the SFC request r has only one outgoing link, and an egress node has only one incoming link, so as to process a user request; and at any intermediate node on a path selected for the SFC request r, SFC^{r} uses only one incoming link and one outgoing link; and if and only if SFC r uses a physical link e_{τi,\hat{τ}j}, a variable

$${y}_{r}^{{e}_{τ i , \hat{τ} j}}$$

is equal to 1:

$${\sum }_{{n}_{{e}_{τ i , \hat{τ} j} , 1} = {s}_{r}} {y}_{r}^{{e}_{τ i , \hat{τ} j}} = 1 , ∀ {Γ}_{r} ∈ Γ , \qquad ( 16 )$$

$${\sum }_{{n}_{{e}_{τ i , \hat{τ} j} , 2} = {t}_{r}} {y}_{r}^{{e}_{τ i , \hat{τ} j}} = 1 , ∀ {Γ}_{r} ∈ Γ , \qquad ( 17 )$$

$$\text{?} \qquad ( 18 )$$

$$\text{?} \text{indicates text missing or illegible when filed}$$

(4) designing a layered architecture and a deployment and migration mechanism, where
a multi-layer network architecture is adopted, each VNF corresponds to an independent layer of network, a matching relationship between each VNF and all nodes is calculated based on an analytic hierarchy process, and a multi-layer network weighted graph is constructed, where a shortest path for deploying an SFC and a placement node of the VNF are determined from the multi-layer weighted graph based on a dynamic programming algorithm, and a migration policy of the VNF-dependent software is determined after the placement node of the VNF is obtained.

Further, in the method, the terminal user initiates extreme service request information to the intra-domain SDN controller; the intra-domain SDN controller transmits the information to the central SDN controller; and the central SDN controller decides that the multi-domain network provides a deployment location and the migration policy of the VNF-dependent software for the service function chain in conjunction with the method for SFC deployment based on VNF-dependent software migration, thereby reducing an end-to-end communication latency and resource usage cost of a service, and a VNF-dependent software resource usage cost and the VNF-dependent software migration cost, and ensuring load balancing of the multi-domain network.

In the above solutions, when the network topology and the service request model constructed in step (2) are used to implement SFC deployment, VNF instantiation not only depends on a virtualization technology, but also needs to fully consider software resource adaptability of a physical node, including considering network attributes such as a capability of computing nodes, and a bandwidth and latency of a link in a multi-domain network implemented based on the network topology, and describing intra-domain and inter-domain communication topologies by using a graph model; defining a plurality of service request types, extracting key indicators of network attributes thereof, and simulating dynamicity of request arrivals by using a random process; and determining a VNF-dependent software migration model based on two established models.

Further, the layered architecture design and the deployment and migration mechanism in step (4) are specifically as follows:

(41) algorithm initialization, where

a multi-layer network structure is constructed, where each VNF corresponds to an independent layer and is used to calculate a matching relationship between each VNF and all nodes; and

a multi-dimensional resource indicator is introduced, where in an initialization phase, a network graph MGᵣₕ is generated for each VNF in the SFC; and independent network graphs MGᵣₕ are connected to each other through corresponding nodes, thereby constructing a multi-layer network graph MGᵣ with a number of layers being |Fᵣ|.

(42) AHP-based performance metrics, where
first, data of each layer of physical nodes is extracted from the multi-layer network graph MGᵣ, including remaining computing, memory, and storage resources, software resources, and processing latencies; next, a pair-wise comparison matrix NCM is constructed for evaluating a criterion layer for a target; then, to compare pairing relationships of same-type elements of all nodes in the multi-layer network graph MGᵣₕ, eight |N|×|N| matrices are constructed, and are named computing resource utilization

$$N C {M}_{r h}^{cu} ,$$

memory resource utilization

$$N C {M}_{r h}^{m u} ,$$

storage resource utilization

$$N C {M}_{r h}^{su} ,$$

storage resource usage cost

$$N C {M}_{r h}^{s m} ,$$

reciprocal of remaining computing resources

$$N C {M}_{r h}^{irc} ,$$

reciprocal of remaining memory resources

$$N C {M}_{r h}^{irm} ,$$

reciprocal of remaining storage resources

$$N C {M}_{r h}^{irs} ,$$

and processing latency

$$N C {M}_{r h}^{p d} ,$$

respectively, and a consistency test is performed on the matrices, where
a consistency ratio is used for evaluating consistency of the matrix, and a consistency index CI is defined as

$$C I = \frac{{λ}_{max} - \vert N \vert}{\vert N \vert - 1}$$

and used for quantifying and determining a degree of consistency in the matrix, where λₘₐₓ represents a maximum eigenvalue of the matrix;
a random consistency index RI depends on dimensions of the matrix and is obtained from a known RI value table;
if the matrix satisfies a consistency standard, an eigenvector corresponding to the maximum eigenvalue is extracted; otherwise, the matrix is reconstructed; and then an indicator value of h_{τi} is calculated; and
a link indicator is calculated by using a similar method, where an indicator value of an inter-layer link is set to 0 all the time; and through the foregoing iterative process, a multi-layer weighted network is finally generated and denoted as MWGᵣ; and

(43) SFC deployment and VNF-dependent software migration policies, where
after a multi-layer weighted graph MWGᵣ is obtained, a next task is to determine a communication path from the source node to the target node and a node for placing the VNF, which is specifically as follows:
first, a starting node is mapped to a node label in MWGᵣ; for each layer, one placement node is selected for the VNF, and metrics of an intra-layer link and an inter-layer communication link are calculated; then comprehensive metrics of the selected placement service node and links are calculated; and finally, the selected deployment service node and communication link are returned; and
a potential software migration scenario is considered during calculation of the metric of the service node, such that an optimal migration policy is selected based on VNF placement.

In terms of implementation and principles, the method for SFC deployment based on VNF-dependent software migration in a multi-domain network in the present disclosure is mainly implemented from the following four perspectives:

(1) A multi-domain network communication architecture is constructed based on SDN controllers. In the multi-domain network communication architecture based on the SDN controllers, a control plane is separated from a data plane to aggregate global information (topology, traffic, etc.) of the multi-domain network, thereby reducing operation and maintenance complexity, achieving cross-domain resource optimization, supporting rapid deployment of new functions and services, and facilitating the flexibility of network management. At the same time, the constructed architecture fully considers the heterogeneity of the multi-domain network, the difference in service node resources, and the diversity of extreme service demands, provides a technical foundation for intelligent, agile, and efficient operation and maintenance of the multi-domain network, and supports higher-level service innovation and service differentiation. The architecture includes a master SDN controller, a domain-specific SDN controller, a communication link between the master SDN controller and the domain-specific SDN controller, a communication link between a user in the domain and the domain-specific SDN controller, and a communication instruction information definition and design.

(2) A network topology and a service request model are established. In SFC deployment, VNF instantiation not only depends on the virtualization technology, but also needs to fully consider the software resource adaptability of a physical node. The VNF instance is usually provided in the form of a virtual machine or a container image. Although the deployment process is simplified, the operation thereof depends on specific software resources. These resources include system-level software (such as Ubuntu, VEKET, and CentOS), configuration files (such as network interface files and routing rule configuration files), application-level software (such as IPFilter and Hash Switch), and the like. These are referred to as VNF-dependent software resources, are important software in constructing the network topology and the service request model, and are crucial to ensuring the normal operation and quality of service of the VNF. The network topology and the service request model that consider VNF-dependent software resources are established, such that VNF resources and demands can be finely managed and the smooth implementation of diversified service scenarios can be promoted.

(3) A problem to be solved is formulated and an optimization objective is determined. The problems of SFC deployment and VNF-dependent software migration in the multi-domain network are formulated, where a plurality of domains are interconnected by an SDN controller. The objective is to reduce the communication latency and costs related to service provision while ensuring the load balancing of the multi-domain network and satisfying constraint conditions related to links and physical node resources. To resolve the problems, a comprehensive decision-making process is required, including strategic placement of VNFs, selection of the optimal communication link, and a proper VNF-dependent software migration policy. Considering the complex coupling between the SFC deployment decision and the VNF-dependent software migration, the two sub-problems are integrated into one problem, and a problem of ensuring the load balancing of the multi-domain network while minimizing the end-to-end communication latency and costs related to service provision is proposed.

(4) A Layered architecture, and a deployment and migration mechanism are designed. The VNFs in the SFC have different computing, memory, and software resource demands, and each physical node has different matching degrees for VNF placement. This increases the complexity of service delivery. A multi-layer network architecture is proposed, and each VNF corresponds to an independent layer of network; in order to calculate the matching relationship between each VNF and all nodes based on an analytic hierarchy process, a multi-layer network weighted graph is further constructed. The shortest path for deploying an SFC and the placement node of the VNF are determined from the multi-layer weighted graph based on a dynamic programming algorithm, and a migration policy of the VNF-dependent software is determined after the placement node of the VNF is obtained. The designed layered architecture and the proposed deployment and migration mechanism enable the VNF to be placed on a suitable physical node, thereby effectively solving challenges caused by VNF-dependent software resource requests.

Beneficial effects: The present disclosure provides a method for SFC deployment based on VNF-dependent software migration in a multi-domain network. In the method, information about multi-domain network topology and diversified extreme service request information are comprehensively considered. Information related to the multi-domain network is initialized first, and then a multi-layer network framework is constructed to support SFC deployment. Then, a multi-layer weighted network is established by using an analytic hierarchy process, and the SFC deployment policy and the VNF-dependent software migration policy are executed on this basis. Finally, a comprehensive experimental evaluation is performed, and the results reveal that the JSD-VDSM algorithm proposed in the present disclosure is superior in performance to other comparison algorithms.

### BRIEF DESCRIPTION OF THE DRAWINGS

FIG. 1 shows a schematic flowchart of the method according to the present disclosure.

FIG. 2 shows a diagram of an example of SFC deployment considering VNF-dependent software migration across domains according to the present disclosure.

FIG. 3 shows a diagram of an example of implementing a JSD-VDSM algorithm according to an embodiment of the present disclosure;

FIG. 4 shows a diagram of AHP-based node link performance metrics according to an embodiment of the present disclosure;

FIG. 5 shows average acceptance rates under different arrival rates of SFC requests according to an embodiment of the present disclosure, where N_{τ}=8;

FIG. 6 shows average SFC acceptance rates that change over time under specific arrival rates according to an embodiment of the present disclosure, where N_{τ}=8;

FIG. 7 shows average SFC acceptance rates under different QoS requests and network sizes according to an embodiment of the present disclosure, where FIG. 7(a) corresponds to λ=0.1 and N_{τ}=8, and FIG. 7(b) corresponds to λ=0.1;

FIG. 8 shows average end-to-end communication latencies under different arrival rates of SFC requests according to an embodiment of the present disclosure, where N_{τ}=8;

FIG. 9 shows average SFC end-to-end communication latencies that change over time under specific arrival rates according to an embodiment of the present disclosure, where N_{τ}=8.

FIG. 10 shows average SFC end-to-end communication latencies under different QoS requests and network sizes according to an embodiment of the present disclosure, where FIG. 10(a) corresponds to λ=0.1 and N_{τ}=8, and FIG. 10(b) corresponds to λ=0.1;

FIG. 11 shows average resource usage costs under different arrival rates of SFC requests according to an embodiment of the present disclosure, where N_{τ}=8.

FIG. 12 shows average SFC resource usage costs under different QoS requests and network sizes according to an embodiment of the present disclosure, where FIG. 12(a) corresponds to λ=0.1 and N_{τ}=8, and FIG. 12(b) corresponds to λ=0.1;

FIG. 13 shows relative storage resource usage costs under different arrival rates of SFC requests according to an embodiment of the present disclosure, where N_{τ}=8.

FIG. 14 shows average SFC relative storage resource usage costs under different QoS requests and network sizes according to an embodiment of the present disclosure;

FIG. 15 shows average software migration costs under different arrival rates of SFC requests according to an embodiment of the present disclosure, where N_{τ}=8.

FIG. 16 shows average SFC software migration costs under different QoS requests and network sizes according to an embodiment of the present disclosure;

FIG. 17 shows load balancing under different arrival rates of SFC requests according to an embodiment of the present disclosure, where N_{τ}=8.

FIG. 18 shows load balancing under different QoS requests and network sizes according to an embodiment of the present disclosure;

FIG. 19 shows an impact of change in SFC length on algorithm performance according to an embodiment of the present disclosure, where N_{τ}=8.

### DETAILED OF THE EMBODIMENTS

To explain the technical solutions disclosed in the present disclosure in detail, the present disclosure will be further described below with reference to the drawings and embodiments.

The present disclosure provides a method for SFC deployment based on VNF-dependent software migration in a multi-domain network, aiming to minimize end-to-end communication latency, improve quality of service (QoS), balance load of the multi-domain network, ensure resource utilization efficiency, reduce deployment overheads, and optimize resource utilization and service costs.

From an application perspective of the present disclosure, with significant progress made in the application and wide deployment of 5G technologies worldwide, public communication capabilities and quality of service have been significantly improved. The progress has significantly accelerated the digital transformation of various vertical industries and promoted social-economic development. In the 6G era, there is an ever-growing demand for extreme services, including immersive extended reality (XR), holographic communication, perception-based interconnection, intelligent interaction, and the like. These services are characterized by low latency and cost effectiveness. The multi-domain network is constructed and managed by different network operators and service providers, and plays a critical role in meeting extreme service demands and providing high-performance communications services due to the characteristics of large capacity and wide coverage. In light of the advantages of the multi-domain network and extreme service demands, the present disclosure provides an SFC deployment policy based on VNF-dependent software migration in a multi-domain network.

The method for SFC deployment based on VNF-dependent software migration in a multi-domain network provided in the present disclosure is used for the integrated deployment of SFC and VNF-dependent software migration. Using the analytic hierarchy process and dynamic programming, the method aims to minimize the end-to-end communication latency and service delivery cost of SFC.

The implementation process of the technical solutions provided in the present disclosure is specifically described below.

The method described in the present disclosure is for implementing the deployment of service function chains and the migration decision of VNF-dependent software. Master software defined network (SDN) controllers, domain-specific SDN controllers, extreme service demands, and multi-domain network topology are mainly included. A domain-specific SDN controller collects network topology and extreme service request information within the current domain and transmits the information to a master SDN controller, and is responsible for SFC deployment and VNF-dependent software migration. A terminal user makes a deployment request to the intra-domain controller, and waits for a network node to provide services. Nodes and links in the multi-domain network topology are scheduled by the master SDN controller to provide services for the terminal user.

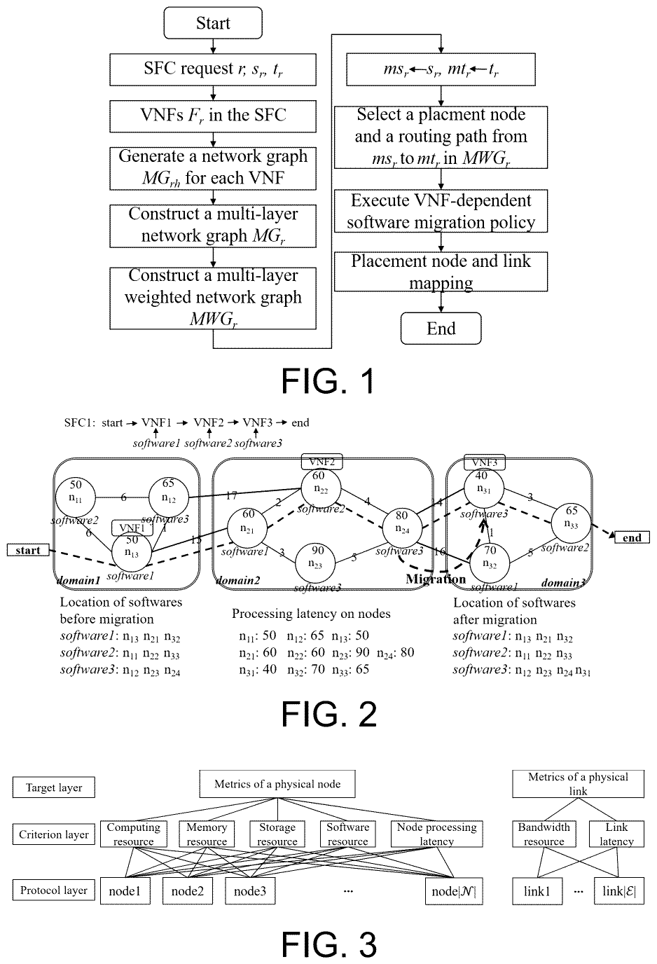

The main implementation process of the method described in the present disclosure is shown in FIG. 1. Based on the above technical solutions, the process is further described in detail in the embodiments, which specifically includes the following steps:

(1) A multi-domain network communication architecture is constructed based on an SDN controller. In the present disclosure, the construction of the multi-domain network communication architecture based on the SDN controller aims to achieve the high flexibility, scalability, and automatic management of a network. A software-defined control plane is used, and resources, traffic, and service functions between different network domains are scheduled and managed in a unified manner by using a centralized SDN controller, thereby achieving the global optimization of the network, improving performance, ensuring quality of service, and significantly reducing the complexity of network operation and maintenance. The architecture not only supports cross-domain collaboration and resource sharing, but also can dynamically adapt to changes in demands of different service scenarios and provide flexible, reliable, and efficient network services to meet diversified and complex service demands at present.

Further, in the present disclosure, the domain-specific SDN controller transmits a request to a central SDN controller according to the service demands of the terminal users. Under hypothetical conditions, each terminal user has an extreme service request, and the multi-domain network needs to provide the resources required by the service request to the terminal user. The purpose of the service is to reduce the end-to-end latency of service function chains, the resource usage cost, the VNF-dependent software migration cost, and the resource usage cost during the placement of VNF-dependent software, while ensuring the load balancing of the multi-domain network. Reduction in the end-to-end latency may increase the resource usage cost and cost related to VNF-dependent software, and may lead to network load imbalance. The cost reduction may result in excessively long communication latency. How to balance the three objectives and how to deploy the SFC while considering VNF-dependent software are the difficulties of this problem.

(2) A network topology and a service request model are established. In the present disclosure, the network topology and the service request model are established, thereby ensuring the accurate adaptation and efficient management of software resources during VNF instantiation. A VNF-dependent software resource identification and matching mechanism is introduced, and the dynamic adaptation of system-level and application-level resources (such as Ubuntu, VEKET, CentOS, IPFilter, and Hash Switch) is used, thereby effectively ensuring that each VNF instance can operate on the most suitable physical node and meet the performance and reliability demands thereof. In addition, through intelligent optimization of resource scheduling, configuration management, and cross-domain collaboration, the efficient instantiation, stable operation, and excellent quality of service assurance of the VNF are achieved, thereby promoting the smooth deployment and implementation of diversified service scenarios.

Further, the present disclosure first models the multi-domain network, including defining the resource attributes of each domain, such as the capacity of computing nodes and the bandwidth and latency of a link, describing intra-domain and inter-domain communication topologies, and representing the topology by using a graph model; then models extreme service requests, defining multiple service request types, extracting key indicators thereof, such as maximum allowable latency, and simulating the dynamicity of request arrivals by using a random process; and determines a VNF-dependent software migration model based on the two established models. A systematic framework is provided through model building, which can clearly describe the characteristics of a multi-domain network, the demand for a service request, and the dependency relationship for VNF migration, thereby avoiding the problem of ambiguity or uncertainty in the design process.

(3) Problems to be solved are formulated and an optimization objective is determined. According to the present disclosure, given the complex coupling relationship between SFC deployment decisions and VNF-dependent software migration, it is difficult to effectively process these interdependent decisions by using a conventional method. To this end, an integrated solution is proposed, which integrates the two sub-problems into an overall optimization problem, with the objective of minimizing the end-to-end communication latency and costs related to service provision, while ensuring the load balancing of a multi-domain network. This integration method successfully breaks through the limitation of a conventional single optimization policy, and provides a brand new solution for complex multi-domain network SFC deployment and VNF-dependent software migration.

Further, in the present disclosure, an SFC deployment policy based on VNF-dependent software migration applicable to a multi-domain network environment is researched and designed. SFC deployment in the multi-domain network faces dual challenges of complexity and resource constraints, especially the adaptation and migration of VNF-dependent software resources, which directly affect service performance and deployment efficiency. Through in-depth analysis of the resource distribution characteristics in the multi-domain network environment and the demands for VNF instantiation, the following objectives are determined: minimizing end-to-end communication latency and improving quality of service; balancing multi-domain network load to ensure resource utilization efficiency; and reducing deployment overheads and optimizing resource utilization and service costs. In this way, deep coupling and optimization between VNF-dependent software migration and SFC deployment is achieved, thereby effectively resolving the problem of resource adaptability and migration complexity.

(4) A layered architecture and a deployment and migration mechanism are designed. According to the present disclosure, a layered architecture and a deployment and migration mechanism are designed. The design of the multi-layer network architecture scheme and the deployment and migration mechanism ensures that the VNF can be precisely placed based on computing, memory, and software resource demands thereof and the matching degree thereof with a physical node. A matching relationship between each VNF and all physical nodes is calculated by using an analytic hierarchy process, and the adaptability of each node is effectively quantized by using a multi-layer network weighted graph, thereby providing a systematic decision basis for optimal placement of the VNF. In addition, by using a dynamic programming algorithm, the shortest path selection for SFC deployment and the precise determining of a VNF placement node are achieved, thereby ensuring the efficient migration and proper scheduling of VNF-dependent software resources.

Further, in the present disclosure, a multi-layer network architecture is introduced, and a matching degree between a VNF and a physical node is calculated by using an analytic hierarchy process, so as to optimize a resource placement decision. The optimal SFC deployment path and node are selected from the multi-layer weighted network by using a dynamic programming algorithm, thereby improving deployment efficiency and reducing communication latency. A dependent software migration optimization mechanism is designed to achieve the efficient migration of software resources in a cross-domain environment and reduce service delivery overheads.

Further, the problem described in step (1) is described by using an example. FIG. 2 illustrates an SFC deployment example in which VNF-dependent software migration is considered in a large network. The network includes three domains with different characteristics, each domain is provided with different software resources, each domain is provided with one SDN controller, and these SDN controllers are controlled by the master SDN controller. To simplify the problem, it is assumed that each physical node is provided with only one software resource, or there is no software resource. For example, in domain1, the physical node n₁₁ is assigned with software2, the physical node n₁₂ is configured with software3, and the physical node n₁₃ is assigned with software1 In domain2, each node is separately equipped with software1, 2, 3, and 3. Similarly, in domain3, each node is separately provided with software0, 1, and 2. software0 indicates that there is no software resource on the physical node n₃₁. The diversity of physical node resources and the related resource usage cost will be discussed in detail in subsequent modeling and methods. In addition, it is assumed that each physical node can host only one VNF instance.

For the specified SFC1: start→VNF2→VNF3→end, the source node and the target node serve as the communication end points; the routing path between the communication end points is determined with the objective of minimizing the link and node processing latency and service delivery cost, and the VNFs are placed on the physical nodes on the path. For example, FIG. 1 illustrates the communication path selected by SFC1, represented by the green dashed line. The deployment process of SFC1 involves two key problems: determining the optimal node for placing the VNF, and evaluating whether software migration needs to be performed when deploying a VNF on a physical node, including selecting which software to migrate. VNF1, VNF2, and VNF3 are deployed on nodes n₁₃, n₂₂, and n₃₁, respectively. The node needs to have a software resource that supports the operation of each VNF. It is observed that the node n₃₁ lacks the software resource required by VNF3. Therefore, software3 needs to be migrated from the node n₂₄ to the node n₃₁, which introduces migration costs. Therefore, the end-to-end communication latency and service delivery cost of SFC1 are calculated as (50+60+40)+(15+2+4+14+3)+14=202, where the first item represents the node processing latency, the second item represents the link latency, and the third item represents the cost of migrating software3 from n₂₄ to n₃₁.

In the above method, in step (2), [symbol] represents a domain set of a heterogeneous multi-domain physical network, and [symbol] ={G₁, G₂, . . . , G_{τ}, . . . , G_{|G|}}, where G_{τ} represents the τ-th network domain and is responsible for mapping SFCs. G_{τ}=(N_{τ},E_{τ}) N_{τ}={n_{τ1}, n_{τ2}, . . . , n_{τi}, . . . , n_{τ|Nτ|}},and Eτ={e_{τi,τj}|n_{τi},n_{τj}∈N_{τ}} separately represent a physical network node set and a physical network link set in the τ-th domain. Assuming that the multi-domain network supports |K| types of VNFs, VFNs represent more than one VFN, such as firewalls (FWs), deep packet inspection (DPI), and network address translation (NAT), and operate for a long period of time T={1, 2, . . . , t, . . . , |T|} to support the provision of services requested by users. The node set N may deploy virtual machines (VMs) to operate VNFs and forward data. These virtual machines are referred to as VNF instances. Each server node n N, has a maximum computing capability

$${ϕ}_{{n}_{τ i}}^{c}$$

(the superscript c represents a central processing unit (CPU)), a maximum memory capacity

$${ϕ}_{{n}_{τ i}}^{m}$$

(m: memory), and a maximum storage capacity

$${ϕ}_{{n}_{τ i}}^{s}$$

(s: storage), which represent computing, memory, and storage resources of the node, respectively. Each server node belongs to a sub-network, and Oₙ_{_{τi}} is a variable representing a domain to which the server node n_{τi} belongs. The link e_{τi,\hat{τ}j}∈E connects two server nodes n_{τi} and n_{\hat{τ}j}, representing a physical link therebetween. When τ is equal to \hat{τ}, the connection represents an intra-domain link; otherwise, the connection represents an inter-domain link, that is, service nodes on the link belong to different domains, and τ and \hat{τ} are used to represent domains of different physical networks. n_{eτi,τj,}_{¹} and n_{eτi,τj,}_{²} represent the starting node and the ending node of the link e_{τi,\hat{τ}j}, respectively, and subscripts 1 and 2 represent the starting node and the ending node, respectively. Each link is composed of two nodes. bₑ_{_{τi,τj}} is used to represent the bandwidth capacity of the link e_{τi,\hat{τ}j}.

$${\hat{ϕ}}_{{n}_{τ i}}^{c}$$

is used to represent the remaining computing resources of the node n_{τi}, and

$${\hat{ϕ}}_{{n}_{τ i}}^{m}$$

represents the remaining memory resources of the node n_{τi}.

$${\hat{ϕ}}_{{n}_{τ i}}^{s}$$

used to represent the remaining storage resources of the node n_{τi}. \hat{b}ₑ_{_{τi,\hat{τ}j}} represents the remaining bandwidth resources of the link e_{τi,\hat{τ}j}.

All user requests that enter the network function virtualization (NFV)-based multi-domain network and have actual demands (such as bandwidth demands and latency requirements) are represented as SFC requests. Γ={Γ₁, Γ₂, . . . , Γᵣ, . . . , Γ_{|Γ|}} is used to represent an SFC request set. A 5-tuple {sᵣ, dᵣ, bᵣ, l̅ᵣ, Gᵣ} is used to define an SFC request r, where sᵣ, dᵣ∈N represent the source node and the target node, respectively. Each SFC request r has a known bandwidth demand bᵣ and a maximum tolerable end-to-end latency requirement l̅ᵣ. The SFC request r consists of a group of predefined VNFs and links, and is represented as a directed weighted graph Gᵣ={Fᵣ,Eᵣ,}, where Fᵣ={ƒᵣ₁, ƒᵣ₂, . . . , ƒᵣₕ, . . . , ƒ_{r|F}_{ᵣ}_{|}} represents a set of VNFs, and Eᵣ={ξ_{ƒrg,ƒrh}|ƒ_{rg}, ƒᵣₕ∈Nᵣ} represents a set of virtual network links. Each VNF ƒᵣₕ∈Fᵣ requires a certain amount of server computing resources

$${R}_{{f}_{rh}}^{c}$$

and a certain amount of memory resources

$${R}_{{f}_{rh}}^{m} .$$

Similarly, mapping a virtual link requires a certain amount of bandwidth resources bᵣ.

The NFV-based multi-domain network is enabled to provide |K| types of VNFs. VNFs of special types operating in a virtual environment require some dependent software to support the operation thereof, and the dependent software required by different types of VNFs is different. However, due to the heterogeneity of the multi-domain network and the limitation of storage resources, it is unrealistic to accommodate all dependent software that supports the operation of the VNF on each server. This means that each server node supports only several specific types of VNFs. Typically, one server node does not need to support all types of VNFs, because in an NFV-based network, software is a resource that can be migrated.

The migration of the VNF-dependent software refers to a process of migrating software from one server node to another server node due to insufficient resources of the software. For example, when a VNF ƒᵣₕ is decided to be deployed on the server node n_{τi} with insufficient software resources, related dependent software of ƒᵣₕ is migrated to the node n_{τi}. Ψ={Ψ₁, Ψ₂, . . . , Ψ_{q}, . . . , Ψ_{|Ψ|}} represents a set of all software resources supporting the operation of the VNF. Before describing a software migration model, the mapping relationship between an SFC request and a physical network topology, that is, VNF placement and logical link mapping, is first described. The relationship is defined by using two binary decision variables:

$${x}_{{f}_{rh}}^{{n}_{τ i}} = \{ \begin{matrix}1 , & {f}_{rh} is placed on node {n}_{τ i} , \\ 0 , & otherwise .\end{matrix} \qquad ( 1 )$$

$${y}_{{ξ}_{{f}_{rg} , {f}_{rh}}}^{{e}_{τ i , \hat{τ} j}} = \{ \begin{matrix}1 , & {ξ}_{{f}_{rg} , {f}_{rh}} is mapped on link {e}_{τ i , \hat{τ} j} , \\ 0 , & otherwise .\end{matrix} \qquad ( 2 )$$

It is worth noting that the logical link ξ_{ƒrg,ƒrh} may be mapped onto a plurality of physical links, because communication between logically adjacent VNFs may span a plurality of physical connections.

The process of the VNF-dependent software migration is described below. It is assumed that the operating time period of the NFV-based multi-domain network is equally divided into a plurality of time slots. It is assumed that new SFC request information is collected in the time slot t−1, the SFC is deployed in the time slot t, and meanwhile, the migration of the software Ψ_{q} is executed and completed in the time slot t. A binary variable

$${Y}_{{n}_{τ i}}^{{f}_{rh}} ( t )$$

indicates whether the server node n_{τi} supports the VNF ƒᵣₕ in the time slot t, and

$${χ}_{{ψ}_{q}}^{{n}_{τ i}} ( t )$$

is a binary migration decision variable indicating whether the software Ψ_{q} is migrated for the node n_{τi} within the time slot t

$${Y}_{{n}_{τ i}}^{{f}_{rh}} ( t ) = {\prod }_{{ψ}_{q} ∈ {Ψ}_{rh}} {Z}_{{n}_{τ i}}^{{ψ}_{q}} ( t ) \cdot ResourceConstraint , \qquad ( 3 )$$

Here,

$${Z}_{{n}_{τ i}}^{{ψ}_{q}} ( t )$$

is a binary variable indicating whether the software Ψ_{q} is on the node n_{τi} in the time slot t. Ψᵣₕ denotes a set of dependent software that supports the operation of the VNF ƒᵣₕ ResourceConstraint is an indication variable indicating whether other resources (such as CPU, memory, and storage) on the node n_{τi} are sufficient to support the operation of ƒᵣₕ; when resources on the node n_{τi} are sufficient, the value thereof is 1.

$${χ}_{{ψ}_{q}}^{{n}_{τ i}} ( t ) = [ 1 - {Z}_{{n}_{τ i}}^{{ψ}_{q}} ( t - 1 ) ] \cdot [ {Z}_{{n}_{τ i}}^{{ψ}_{q}} ( t - 1 ) ⊕ {Z}_{{n}_{τ i}}^{{ψ}_{q}} ( t ) ] , \qquad ( 4 )$$

When

$${χ}_{{ψ}_{q}}^{{n}_{τ i}} ( t ) = 1 ,$$

it indicates that the software Ψ_{q} has been migrated to the server node n_{τi} in the time slot t; otherwise, it indicates that the software Ψ_{q} has not been migrated. Next,

$${Ψ}_{{f}_{rh}}^{mig}$$

is used to represent a software resource set that needs to be migrated for the VNF ƒᵣₕ. After the software that needs to be migrated is determined, software resources on a corresponding node need to be updated.

Further, in step (3), a problem to be resolved is first defined, and then a mathematical model for SFC deployment considering VNF-dependent software migration in a multi-domain network is provided.

The problems to be solved are defined as follows:

Definition 1: SFC deployment (SD). Given the network information [symbol] and an SFC request set Γ, the routing path of the SFC and the deployment policy thereof are determined, and the quality of the selected path is considered to minimize the SFC placement cost and ensure the end-to-end latency of the SFC while satisfying the constraint of physical network resources.

Definition 2: VNF-dependent software migration (VDSM). Given the network information [symbol] , the SFC deployment result, and the distribution matrix Z of the current software resource, the migration policy of software and the migration path thereof are determined. Considering the VNF's demand for dependent software, when the selected server node is unable to provide sufficient software resources, migration cost is minimized.

Based on the foregoing two definitions, it is clear that an SFC deployment policy may affect a software migration policy. In turn, the software migration policy may also affect the deployment policy of the SFC in a subsequent time slot. The policies for the two problems are strongly coupled, and thus the two problems are integrated into one, referred to as SD-VDSM.

Objective: The objective of the SD-VDSM problem is to minimize the end-to-end latency of all SFCs and costs related to SFC deployment and VNF-dependent software (dependent software cost, DSC), that is, a VNF-dependent software migration cost (DSMC) and a VNF-dependent software placement cost (DSPC).

The end-to-end latency of the SFC request is defined as the sum of link latencies and the sum of VNF processing latencies on the server node, with the following formula:

$${D}_{r} = {\sum }_{{ξ}_{{f}_{rg} , {f}_{rh}} ∈ {E}_{r}} {\sum }_{{e}_{τ i , \hat{τ} j} ∈ E} {y}_{{ξ}_{{f}_{rg} , {f}_{rh}}}^{{e}_{τ i , \hat{τ} j}} \cdot {l}_{{e}_{τ i , \hat{τ} j}} + {\sum }_{{f}_{rh} ∈ {F}_{r}} {\sum }_{{n}_{τ i} ∈ N} {x}_{{f}_{rh}}^{{n}_{τ i}} \cdot {l}_{{n}_{τ i}} , \qquad ( 5 )$$

where lₑ_{_{τi,\hat{τ}j}} is the latency on the link e_{τi,\hat{τ}j}, and lₙ_{_{τi}} is the processing latency on the node n_{τi}.

Subsequently, the costs related to SFC deployment and DSC are defined. For the server node n_{τi}, the unit CPU cost is expressed as

$${c}_{{n}_{τ i}}^{CPU} ,$$

and the unit memory cost and the unit storage cost are defined as

$${c}_{{n}_{τ i}}^{mem} and {c}_{{n}_{τ i}}^{sto} ,$$

respectively. The three indicators are related to the load state of the node. The symbol * represents the resource type of the service node and may include CPU, memory, or other resources. When the node resource utilization is lower than

$${u}_{min}^{*} ,$$

the unit cost remains at a constant value and is denoted as

$${c}_{min}^{*} .$$

The unit cost is linearly distributed within a range of the node resource utilization from

$${u}_{min}^{*} to {ιι}_{max}^{*}$$

In addition, when the node resource utilization falls within the interval

$$[ {u}_{min}^{*} , 100 \% ] ,$$

the unit cost remains at a fixed value and is denoted as

$${c}_{max}^{*} .$$

Thereafter, the placement cost of the SFCᵣ is defined as

$${C}_{r}^{d} ,$$

while the DSCs of the SFC r deployment are represented by

$${C}_{r}^{s} . {C}_{r}^{d}$$

consists of node resource usage costs, with the following expression:

$${C}_{r}^{d} = {\sum }_{{f}_{rh} ∈ {F}_{r}} {\sum }_{{n}_{τ i} ∈ N} {x}_{{f}_{rh}}^{{n}_{τ i}} \cdot ( {c}_{{n}_{τ i}}^{CPU} \cdot {R}_{{f}_{rh}}^{c} + {c}_{{n}_{τ i}}^{mem} \cdot {R}_{{f}_{rh}}^{m} ) . \qquad ( 6 )$$

With the migration of the VNF-dependent software, additional migration costs are incurred to support SFCᵣ deployment. When software is migrated to the server node n_{τi}, the software occupies a storage resource on the server node, resulting in placement costs of the VNF-dependent software. As regards DSCs, the DSCs consist of DSMCs and DSPCs, which are defined as follows:

$${C}_{r}^{s} = {\sum }_{{f}_{rh} ∈ {F}_{r}} {\sum }_{{ψ}_{q} ∈ {Ψ}_{{f}_{rh}}^{mig}} {\sum }_{{p}_{τ i , \hat{τ} j} ∈ {L}_{{ψ}_{q}}} {y}_{{p}_{τ i , \hat{τ} j}}^{{e}_{τ i , \hat{τ} j}} \cdot {l}_{{e}_{τ i , \hat{τ} j}} + {\sum }_{{f}_{rh} ∈ {F}_{r}} {\sum }_{{ψ}_{q} ∈ {Ψ}_{{f}_{rh}}^{mig}} {x}_{{f}_{rh}}^{{n}_{τ i}} \cdot {χ}_{{ψ}_{q}}^{{n}_{τ i}} \cdot {c}_{{n}_{τ i}}^{sto} \cdot {R}_{{ψ}_{q}}^{s} , \qquad ( 7 )$$

where DSMCs are the first portion, and DSPCs are defined as the second portion. In formula (7), L_{Ψ}_{_{q}} is a path for migrating the software Ψ_{q}, and

$${y}_{{p}_{τ i , \hat{τ} j}}^{{e}_{τ i , \hat{τ} j}}$$

is a binary variable used for determining whether p_{τi,\hat{τ}j} belonging to the path L_{Ψ}_{_{q}} is mapped onto the link e_{τi,\hat{τ}j}, where

$${R}_{{ψ}_{q}}^{s}$$

represents the storage resource usage of Ψ_{q}. It should be noted that when p_{τi,\hat{τ}j} is mapped onto

$${e}_{τ i , \hat{τ} j} , {y}_{{p}_{τ i , \hat{τ} j}}^{{e}_{τ i , \hat{τ} j}} = 1.$$

The service delivery cost Cᵣ of the SFCᵣ is defined as follows:

$${C}_{r} = {C}_{r}^{d} + {C}_{r}^{s} , \qquad ( 8 )$$

It is the sum of SFC placement costs and DSCs.

The SD-VDSM problem relates to selecting an optimal deployment and VNF-dependent software migration policy, so as to improve the quality of service of the SFC and minimize costs related to service delivery. Given that the problem involves multiple decisions, the joint optimization objective is expressed as follows:

$$min {\sum }_{{Γ}_{r} ∈ Γ} {ω}_{1} {D}_{r} + {ω}_{2} {C}_{r} , \qquad ( 9 )$$

where ω₁ and ω₂ are adjustable weight factors for balancing each objective. By adjusting the weight factor of each objective, the preference of a specific objective can be highlighted. In addition, the constraint conditions of physical network resources and the quality of service of the SFC need to be satisfied.

The constraint conditions (10) and (11) ensure that on any server node n_{τi}, the total CPU and memory resource demands required for SFC deployment are restricted to the respective maximum CPU and memory resource capacity:

$${\sum }_{{Γ}_{r} ∈ Γ} {\sum }_{{f}_{rh} ∈ {F}_{r}} {x}_{{f}_{rh}}^{{n}_{τ i}} \cdot {R}_{{f}_{rh}}^{c} \leq {ϕ}_{{n}_{τ i}}^{c} , ∀ {n}_{τ i} ∈ N , \qquad ( 10 )$$

$${\sum }_{{Γ}_{r} ∈ Γ} {\sum }_{{f}_{rh} ∈ {F}_{r}} {x}_{{f}_{rh}}^{{n}_{τ i}} \cdot {R}_{{f}_{rh}}^{m} \leq {ϕ}_{{n}_{τ i}}^{m} , ∀ {n}_{τ i} ∈ N . \qquad ( 11 )$$

The constraint condition (12) ensures that the used storage resources shall not exceed the maximum storage resource capacity:

$${\sum }_{{ψ}_{q} ∈ {Ψ}_{{n}_{τ i}}} {Z}_{{n}_{τ i}}^{{ψ}_{q}} \cdot {R}_{{ψ}_{q}}^{s} \leq {ϕ}_{{n}_{τ i}}^{s} , ∀ {n}_{τ i} ∈ N , \qquad ( 12 )$$

where Ψₙ_{_{τi}} denotes a set of software on the node nτi. Similarly, the total bandwidth consumption on any link e_{τi,\hat{τ}j} must be less than the maximum bandwidth capacity. The constraint condition is as follows:

$${\sum }_{{Γ}_{r} ∈ Γ} {\sum }_{{ξ}_{{f}_{rg} , {f}_{rh}} ∈ {E}_{r}} {y}_{{ξ}_{{f}_{rg} , {f}_{rh}}}^{{e}_{τ i , \hat{τ} j}} \cdot {b}_{r} \leq {b}_{{e}_{τ i , {\hat{τ}}_{j}}} , ∀ {e}_{τ i , \hat{τ} j} ∈ E . \qquad ( 13 )$$

To satisfy the quality of service, the latency constraint (14) ensures that the end-to-end latency of any SFC r must be satisfied with the following constraint condition:

$${D}_{r} \leq {\overline{l}}_{r} , ∀ {Γ}_{r} ∈ Γ . \qquad ( 14 )$$

The constraint (15) ensures that each ƒᵣₕ can be successfully deployed on only one server node at most, which means that the VNF instance is inseparable:

$${\sum }_{{n}_{τ i} ∈ N} {x}_{{f}_{rh}}^{{n}_{τ i}} \leq 1 , ∀ {Γ}_{r} ∈ Γ , ∀ {f}_{rh} ∈ {F}_{r} . \qquad ( 15 )$$

To simplify the SFC deployment, it is assumed that the ingress node of the SFC r has only one outgoing link, and the egress node has only one incoming link, so as to process a user request. At any intermediate node on a selected path of the SFC r, the SFC r uses only one incoming link and one outgoing link. If and only if the SFC r uses the physical link e_{τi,\hat{τ}j}, the variable

$${y}_{r}^{{e}_{τ i , \hat{τ} j}}$$

is equal to 1:

$${\sum }_{{n}_{{e}_{τ i , \hat{τ} j} , 1} = {s}_{r}} {y}_{r}^{{e}_{τ i , \hat{τ} j}} = 1 , ∀ {Γ}_{r} ∈ Γ , \qquad ( 16 )$$

$${\sum }_{{n}_{{e}_{τ i , \hat{τ} j} , 2} = {t}_{r}} {y}_{r}^{{e}_{τ i , \hat{τ} j}} = 1 , ∀ {Γ}_{r} ∈ Γ , \qquad ( 17 )$$

$${\sum }_{{n}_{{e}_{τ i , \hat{τ} j} , 1} = n} {y}_{r}^{{e}_{τ i , \hat{τ} j}} - {\sum }_{{n}_{{e}_{τ i , \hat{τ} j} , 2} = n} {y}_{r}^{{e}_{τ i , \hat{τ} j}} = 0 , ∀ {Γ}_{r} ∈ Γ , ∀ n ∈ N \neq {s}_{r} , {t}_{r} . \qquad ( 18 )$$

Further, in step (4), the SFC deployment method in combination with VNF-dependent software migration is constructed around three main steps: algorithm initialization, calculating the performance of the service node and the link by using the analytic hierarchy process, and finally, performing SFC deployment and VNF-dependent software migration. The flowchart representation of the entire process is shown in FIG. 1. Subsequently, the proposed algorithm is described in detail, and an algorithm procedure is gradually described through the example shown in FIG. 3.

Each VNF in the SFC has different demands on computing, memory, and software resources. Therefore, physical nodes have different matching degrees for VNF placement, thereby increasing service delivery complexity. Therefore, a multi-layer network structure is provided, where each VNF corresponds to one independent layer. This structure facilitates calculating the matching relationship between each VNF and all nodes. Different from previous work, by introducing multidimensional resource indicators, a novel algorithm is proposed. In the initialization phase, a network graph MGᵣₕ is generated for each VNF in the SFC. These independent network graphs are connected to each other through corresponding nodes, thereby constructing a multi-layer network graph MGᵣ with the number of layers being |Fᵣ|.

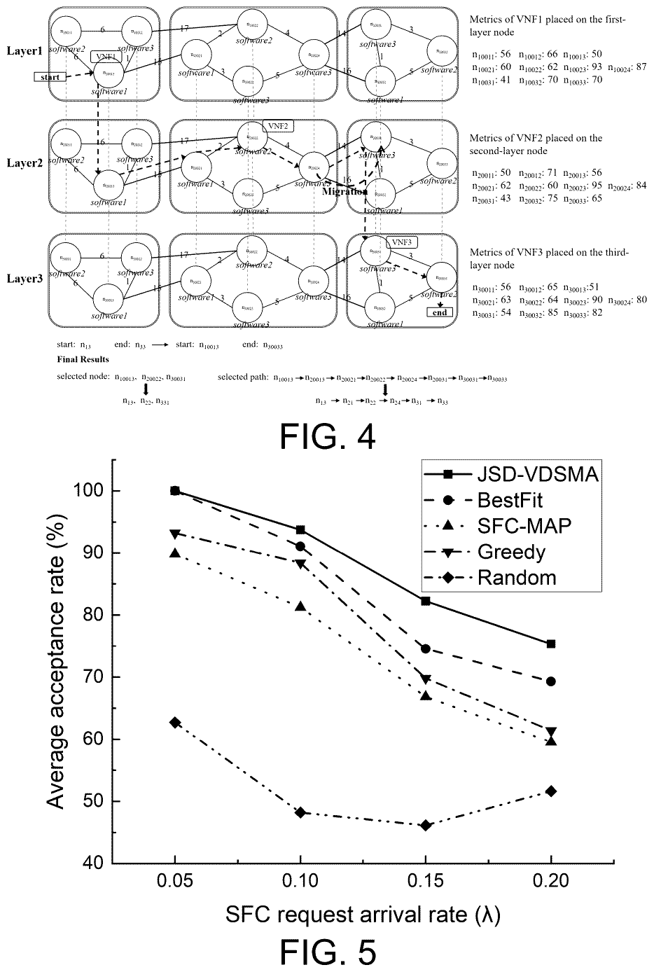

For example, SFC1 includes three VNFs. Therefore, a three-layer network graph consisting of the first layer, the second layer, and the third layer needs to be constructed, as shown in FIG. 3. The inter-layer communication is achieved by connecting corresponding nodes, for example, connecting n₁₀₀₁₁ to n₂₀₀₁₁ and connecting n₂₀₀₁₁ to n₃₀₀₁₁. The connection between corresponding nodes in different layers is defined as an inter-layer link. After the MGᵣ is constructed, the performance indicator of the corresponding VNF deployed on a physical node at each layer needs to be calculated. The multi-dimensional characteristics of the node indicator pose challenges in evaluating the performance of the physical node. When evaluating the performance of the physical node on which the VNF is placed, potential software migration further increases the complexity of the measurement process. The AHP decomposes the problem into a hierarchical structural problem. Using the AHP (as shown in FIG. 4), the performance of the physical node is quantified, and factors such as computing, memory, and storage resources, software resources, and node processing latency are considered. These factors are specifically reflected in indicators such as resource utilization, storage resource usage costs, the reciprocal of remaining computing resources, the reciprocal of remaining memory resources, the reciprocal of remaining storage resources, and node processing latency. Similarly, the performance of the physical link is also evaluated by using the AHP, and factors such as bandwidth resources and link latency are considered. These factors are specifically reflected in indicators such as bandwidth utilization, the reciprocal of remaining bandwidth resources, and the communication latency of the link. In the entire process of node and link performance evaluation, a smaller indicator value is considered to represent better performance. Therefore, a smaller indicator value corresponds to a higher performance of the node and the link. After the multi-layer weighted graph MWGᵣ is acquired, the next task is to determine the communication path from the source node to the target node and a node on which the VNF is placed.

In this embodiment, to verify the actual effect of the present disclosure, simulation experiments are performed. To better illustrate the effect of the present disclosure, SFC-MAP and algorithms based on BestFit, Greedy, and Random are used for comparison, and simulation experiments are implemented using Python 3.7. To simulate a multi-domain network, USANet is selected as the network topology. The topology includes 24 physical nodes and 43 physical links. The topology is divided into three domains, and each domain includes eight physical nodes. In the experiment, all physical nodes are considered as server nodes. On this basis, a scenario in which the number of nodes in each domain is reduced to 7 or increased to 9 is further explored. The effect mainly includes the following aspects:

### (1) Acceptance Rate

FIG. 5 illustrates a comparative analysis of the SFC average acceptance rates at different arrival rates for five different algorithms. It is indicated in the figure that the SFC acceptance rates of JSD-VDSMA, BestFit, SFC-MAP, and Greedy algorithms are on the decline as the SFC arrival rate increases. This phenomenon may be attributed to the proportional increase in the number of accepted SFC requests as the arrival rate increases. However, the number of accepted SFC requests increases relatively slowly, resulting in a decrease in the SFC acceptance rate.

The figure also shows that JSD-VDSMA performs better than other algorithms in terms of acceptance rate, followed by the BestFit algorithm. The Greedy algorithm shows a higher acceptance rate than the SFC-MAP algorithm. This difference may be attributed to the JSD-VDSMA algorithm, which carefully selects the best match for the physical nodes and links used in the SFC deployment. The BestFit algorithm focuses on finding the best match for the VNF and the connection logical link thereof in each SFC. In another aspect, the Greedy algorithm only considers the deployment performance of the VNF on the physical node. In contrast, the SFC-MAP algorithm prioritizes the low latency requirements of the SFC, although this may compromise the acceptance rate.

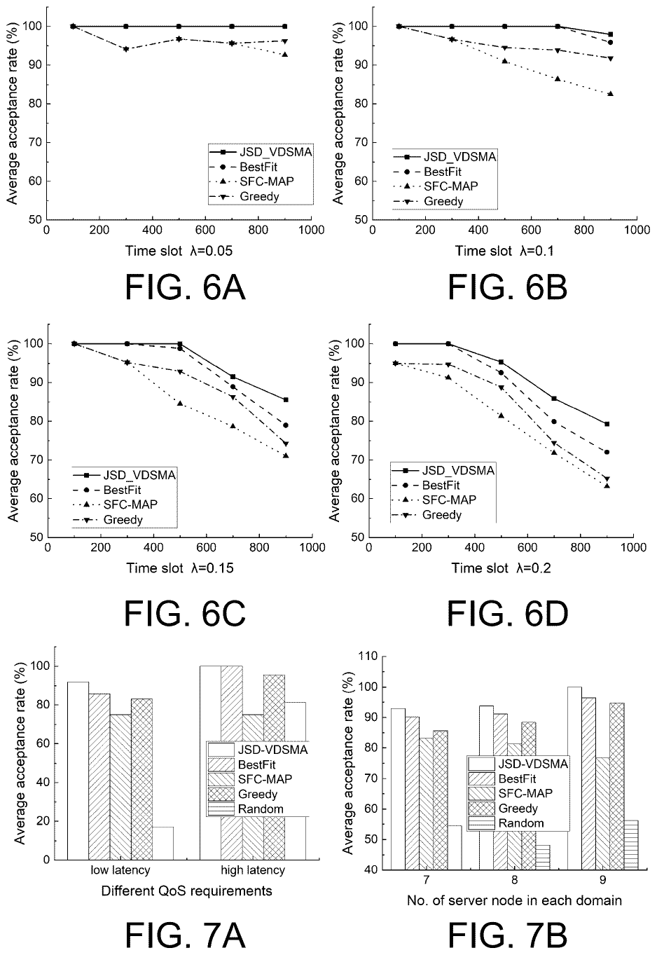

In addition, a case where the SFC acceptance rate fluctuates over time at a fixed arrival rate is further analyzed. As shown in FIG. 6, particularly, it can be seen from FIGS. 6(b), 6(c), and 6(d) that at a specific service arrival rate, the SFC acceptance rate is on the decline as the time slot increases. It can be clearly seen from FIG. 6(a) that when λ=0.05, the SFC acceptance rates under SFC-MAP and Greedy algorithms do not continuously decrease as the time slot increases. This phenomenon is attributed to the fact that although the number of accepted SFC requests increases as the time slot increases, the growth rate of the number of SFC requests accepted in each time slot fluctuates.

The average acceptance rate of the SFC under different QoS requirements and network scales is also analyzed. As shown in FIG. 7(a), in FIG. 7(a), λ=0.1 and N_{τ}=8; FIG. 7(b) corresponds to λ=0.1. Regardless of whether the latency constraint is high or low, JSD-VDSMA maintains a high acceptance rate all the time. Similarly, FIG. 7(b) shows that JSD-VDSMA also maintains a similar high acceptance rate at different network scales.

### (2) Communication Latency

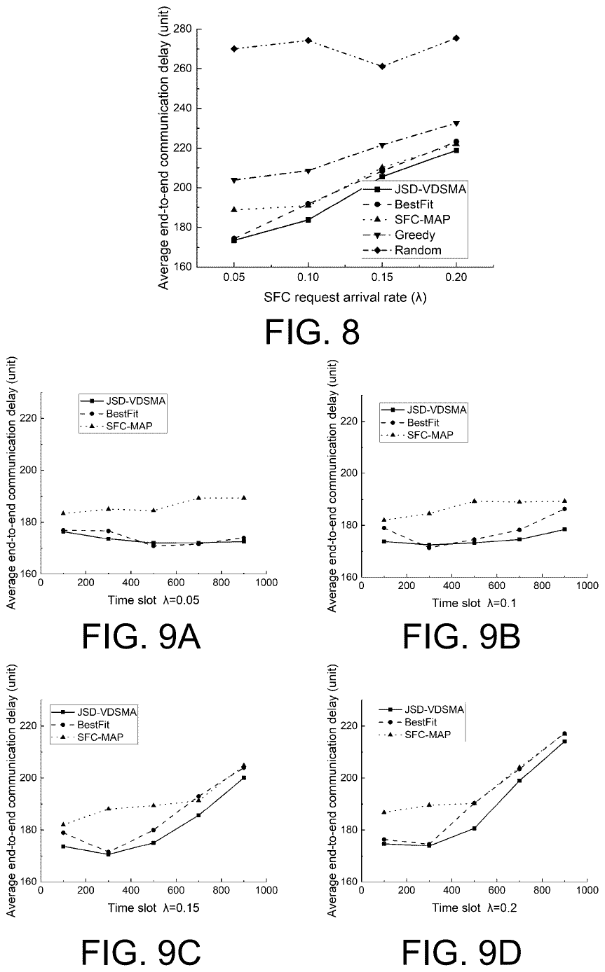

FIG. 8 represents the end-to-end communication latency of the SFC at different arrival rates. As the SFC arrival rate increases, the average end-to-end latency of the SFC under JSD-VDSMA, BestFit, SFC-MAP, and Greedy algorithms is on the rise. The reason for this trend is that as the SFC arrival rate rises, the number of accepted SFCs also increases, resulting in more physical nodes with lower processing latency characteristics being utilized to accommodate additional SFC deployments to provide services, which further encourages physical nodes with higher processing latency characteristics to be used, thereby increasing the average processing latency. In addition, as the number of successfully deployed SFCs increases, a longer physical link is required to support end-to-end communication. This causes a communication latency to increase.

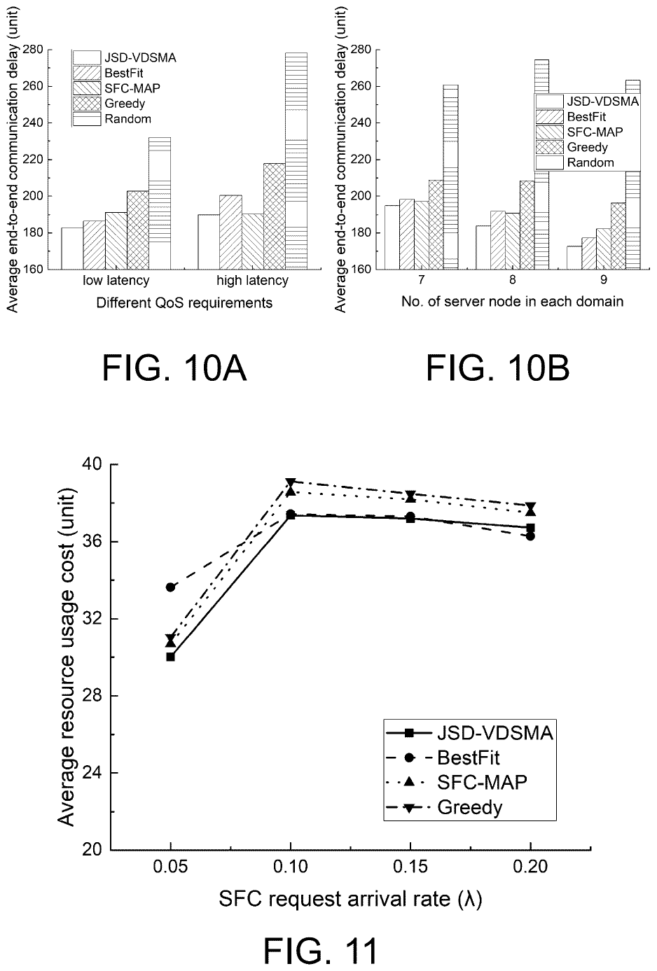

Since JSD-VDSMA, BestFit, and SFC-MAP algorithms perform excellently in terms of average end-to-end communication latency, FIG. 9 illustrates the variation of the SFC average end-to-end communication latency over time for these three algorithms at a specific arrival rate. FIGS. 9(a), 9(b), 9(c), and 9(d) consistently show a rising trend, which is attributed to the increasing number of accepted SFCs as the time slot increases. This results in the occupation of high processing latency nodes, as well as the need for longer physical links to ensure end-to-end communication. FIG. 10 illustrates the end-to-end communication latencies of the SFCs under different QoS requests and network sizes. Under different QoS and network sizes, JSD-VDSMA maintains a lower communication latency all the time, where FIG. 10(a) corresponds to λ=0.1 and N 8; FIG. 10(b) corresponds to λ=0.1.

### (3) Resource Usage Cost

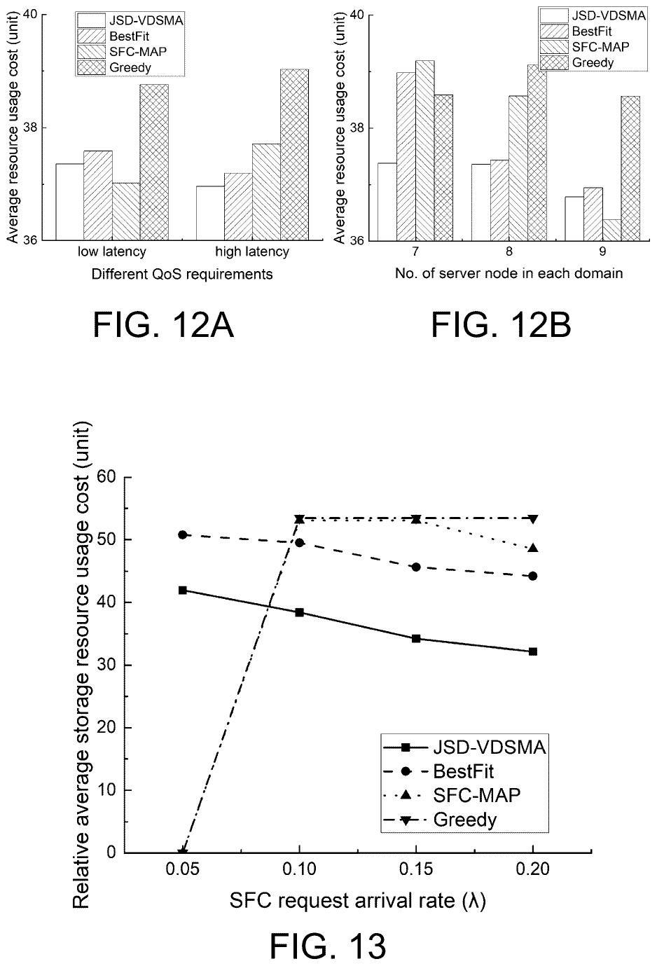

FIG. 11 illustrates the average resource usage cost of the SFC at different arrival rates. In view of the poor performance of the Random algorithm in terms of the SFC acceptance rate and end-to-end communication latency, the focus is solely on demonstrating the performance of JSD-VDSMA, BestFit, SFC-MAP, and Greedy algorithms in terms of resource usage cost. The average resource cost rises significantly as λ increases from 0.05 to 0.1. This is because fewer physical node resources are used when λ=0.05, and the unit cost of resources is proportional to the amount of resources used. When λ=0.1, as the number of deployed SFCs increases, the SFCs tend to be deployed on physical nodes with lower latency and costs. Although the latency of these nodes is relatively low, the relatively high utilization thereof results in a relatively high resource usage cost. While when λ=0.15 and λ=0.2, although the number of deployed SFCs increases, the resource cost remains relatively stable compared to λ=0.1. This is because the optimization objective prioritizes the communication latency and service provision cost of the SFC, such that the SFC is deployed on a physical node with low latency and low cost. As shown in FIG. 12, FIG. 12(a) corresponds to λ=0.1 and N_{τ}=8; FIG. 12(b) corresponds to λ=0.1. Under different QoS constraints and network scales, the proposed algorithm achieves a relatively low resource usage cost.

### (4) Relative Storage Resource Usage Cost

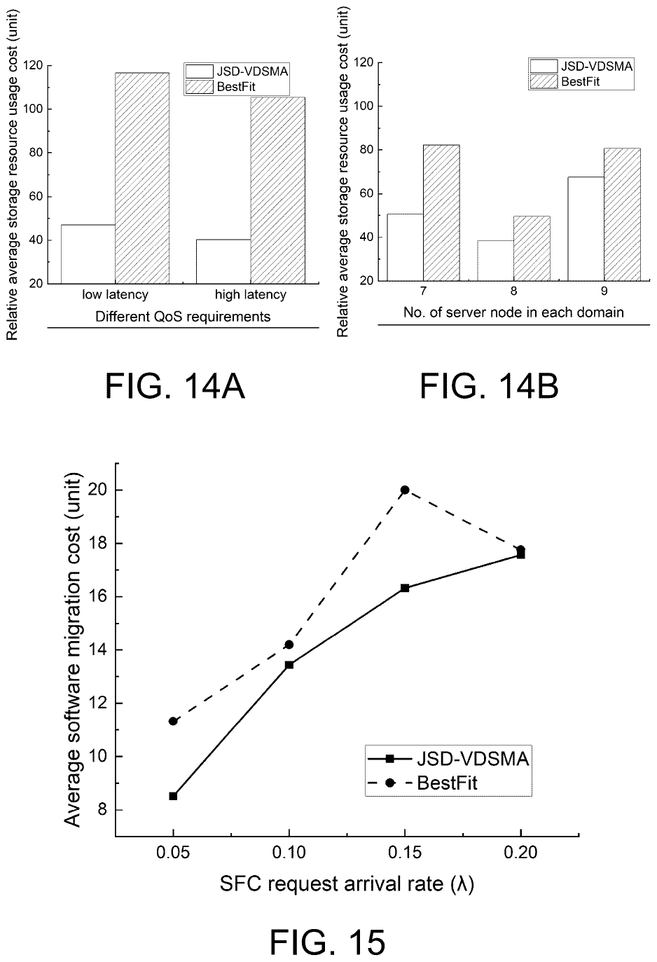

FIG. 13 illustrates the relative average storage resource usage cost of the SFC at different arrival rates. The relative average resource usage cost is obtained by dividing the average storage resource usage cost by the average storage resource utilization. Under JSD-VDSMA and BestFit algorithms, relative average storage resource usage costs gradually decrease as the SFC arrival rate increases. This trend is attributed to an increase in the SFC arrival rate. As a result, the number of accepted SFC requests increases, and more software is required to support the operation of the VNFs, thereby increasing the use of storage resources of the physical nodes. It can be clearly seen from the figure that JSD-VDSMA can fully use the storage resource to accept more SFC requests at a relatively low latency. Under Greedy and SFC-MAP algorithms, when λ=0.05, the relative average storage resource usage cost is almost zero, because the accepted SFCs prioritize the use of existing software. Thereafter, however, the relative average storage resource usage cost remains at a relatively high level. As shown in FIG. 14, FIG. 14(a) corresponds to λ=0.1 and N_{τ}=8; FIG. 14(b) corresponds to λ=0.1.

Under different QoS requirements and network scales, the relative average storage resource usage cost of the SFC under JSD-VDSMA remains relatively low.

### (5) Software Migration Cost and Load Balancing

Through the analysis of the above five algorithms, it can be observed that when the SD-VDSM problem is resolved, JSD-VDSMA and BestFit algorithms perform excellently in terms of acceptance rate, communication latency, resource usage cost, and relative storage resource usage cost. Next, the impact of JSD-VDSMA and BestFit algorithms on the average software migration cost and network load balancing is analyzed.

The software migration cost is defined in formula (7). For example, when the software needs to migrate from the physical node n_{τ1} to n_{τ2}, the shortest latency path from n_{τ1} to n_{τ2} is calculated and used for software migration. FIG. 15 illustrates the average software migration cost of the SFC at different arrival rates. According to the JSD-VDSMA algorithm, as the SFC arrival rate increases, the average migration cost slowly rises. This is because as the SFC arrival rate increases, the number of software migrations increases, resulting in a more even distribution of software resources in the multi-domain network, and consequently, thereby causing the migration cost to gradually increase. Under the BestFit algorithm, when λ=0.15, the average software migration cost is the highest, and the migration cost gradually decreases as A decreases from 0.15 to 0.2. This change is due to the more even distribution of the software when λ=0.2, which reduces the time required for the software to migrate from one location to another location, thereby lowering the average software migration cost.

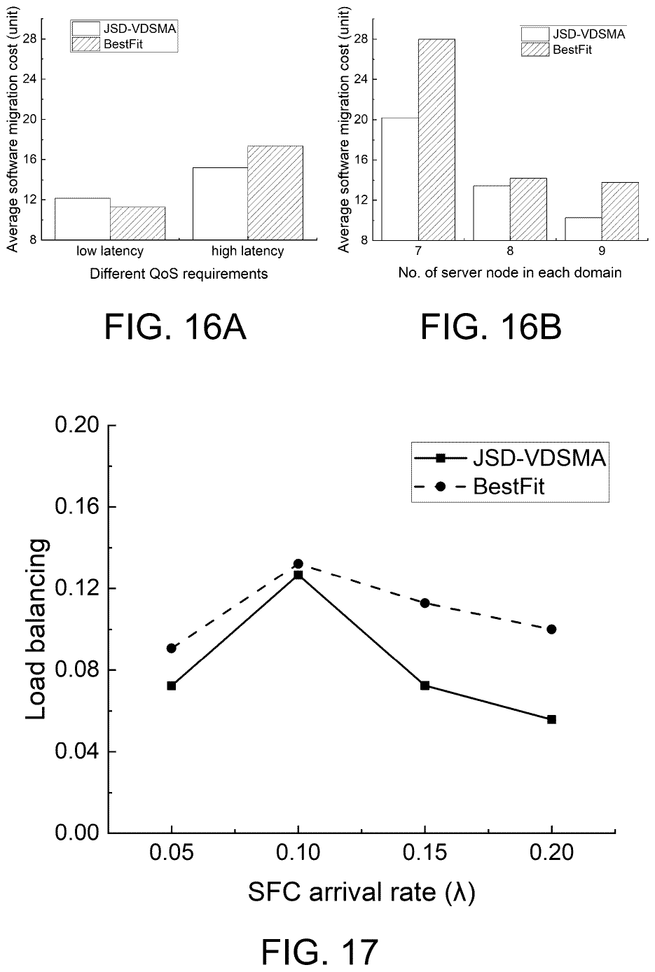

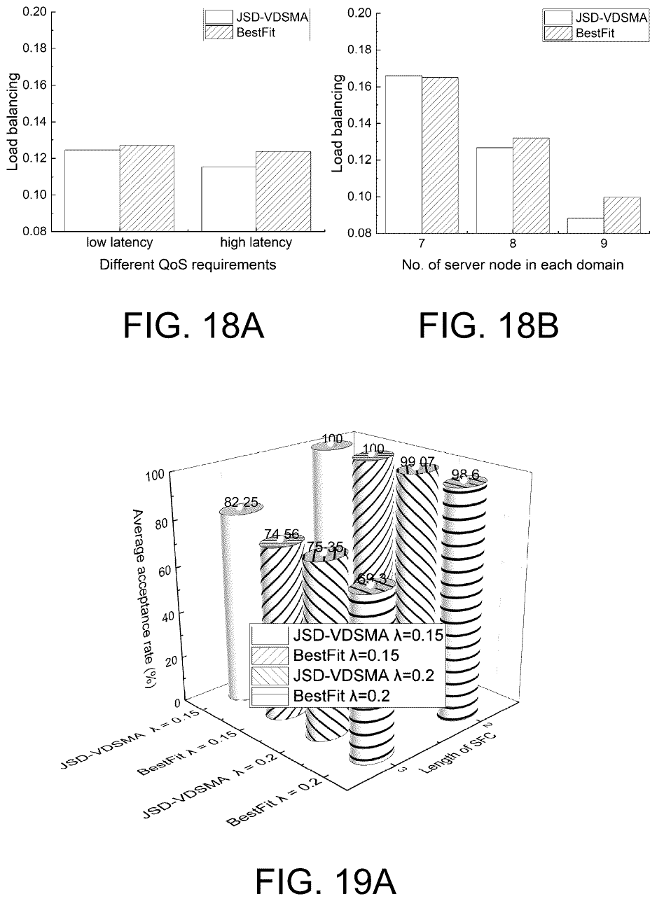

FIG. 17 illustrates the network load balancing under JSD-VDSMA and BestFit algorithms. It can be seen from the figure that when λ=0.1, the load balancing degrees under the two algorithms are both relatively high. Experimental results reveal that when λ=0.1, the SFC occupies a large amount of CPU resources in the third domain, resulting in a more significant load balancing effect. From λ=0.1 to 2=0.2, the load balancing degree is on the decline, which indicates that the SFC is distributed more evenly among the three network domains. FIGS. 16 and 18 illustrate that JSD-VDSMA performs better in terms of the average software migration cost of the SFC and load balancing performance in the multi-domain network under different QoS requirements and network scales.

### (6) Performance of JSD-VDSMA in Different SFC Lengths

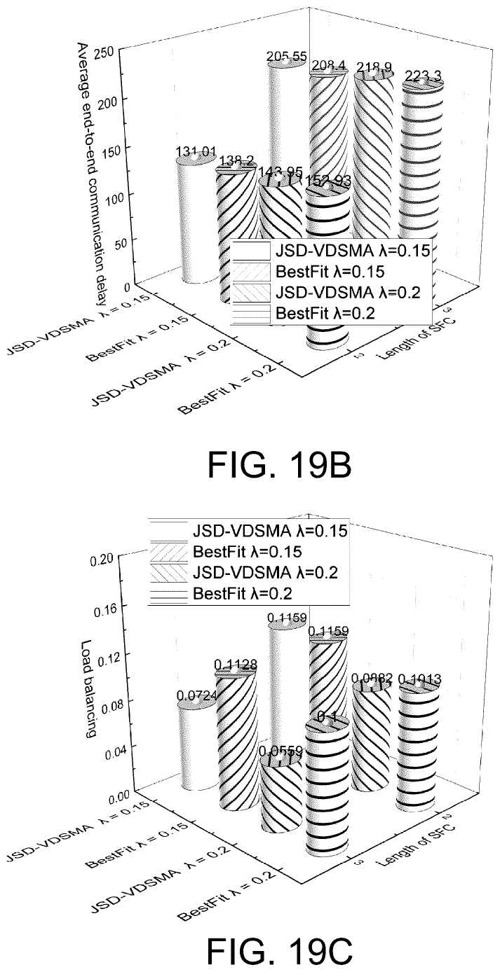

To further illustrate the scalability of JSD-VDSMA, the impact of different SFC lengths on the algorithm performance is analyzed, as shown in FIG. 19. FIG. 19(a) shows the average acceptance rates of JSD-VDSMA and BestFit algorithms when the SFC arrival rates are 0.15 and 0.2, and the SFC lengths are 2 and 3. It can be seen from the figure that when λ is 0.15 and the SFC length is 2, both JSD-VDSMA and BestFit algorithms achieve an acceptance rate of 100%. When λ is 0.2 and the SFC length is 2, the acceptance rate of JSD-VDSMA is slightly higher than that of the BestFit algorithm. In addition, when λ takes the values 0.15 and 0.2, and the SFC length is 3, the acceptance rate of JSD-VDSMA is better than that of the BestFit algorithm all the time. FIG. 19(b) illustrates the average end-to-end latencies of JSD-VDSMA and BestFit algorithms, considering the case of SFC arrival rates of 0.15 and 0.2, and SFC lengths of 2 and 3. When λ takes the values 0.15 and 0.2, and the SFC lengths are 2 and 3, the end-to-end communication latency of JSD-VDSMA is lower than that of the BestFit algorithm all the time. FIG. 19(c) shows the network load condition of JSD-VDSMA and BestFit algorithms when the SFC arrival rates are 0.15 and 0.2, and the SFC lengths are 2 and 3. In terms of load balancing, JSD-VDSMA performs better than the BestFit algorithm, particularly when λ takes the values 0.15 and 0.2, and the SFC lengths are 2 and 3.

In summary, in the experimental results, the algorithm has high performance in terms of service acceptance rate, end-to-end communication latency, resource utilization cost, and the like. Therefore, the method proposed in the present disclosure is generally competitive.

1. A method for service function chain (SFC) deployment based on virtualized network function (VNF)-dependent software migration in a multi-domain network, comprising:
(1) constructing a multi-domain network communication architecture based on a software-defined networking (SDN) controller, wherein the multi-domain network communication architecture comprises a multi-domain physical network, a terminal user, a domain-specific SDN controller, and a central SDN controller; the terminal user initiates a service request to the domain-specific SDN controller; the domain-specific SDN controller transmits information to a central SDN controller; the central SDN controller issues an SFC deployment instruction and a VNF-dependent software migration instruction to the domain-specific SDN controller in conjunction with VNF-dependent software migration; and the multi-domain network provides services for the terminal user according to a decision of the domain-specific SDN controller;
(2) establishing a network topology and a service request model, which specifically comprises:
(21) mapping a service function chain through a heterogeneous multi-domain physical network based on a multi-domain network topology, wherein
a domain set of the heterogeneous multi-domain physical network is represented as [symbol] ={G₁, G₂, . . . , G_{τ}, . . . , G_{|G|}}, wherein G_{τ} represents a τ-th network domain, |G| represents a number of domains, a multi-domain physical network node set is represented as N_{τ}={n_{τ1}, n_{τ2}, . . . , n_{τi}, . . . , n_{τ|N}_{_{τ}}_{|}}, n_{τi} represents i-th node in the network domain τ, a physical network link set is represented as E_{τ}={e_{τi,τj}|n_{τi},n_{τj}∈N_{τ}}, the multi-domain network supports |K| types of VNFs and operates for a long period of time T={1, 2, . . . , t, . . . , |T|} to support provision of services requested by the user, and a node set N is used for deploying virtual machines to operate VNFs and forward data; a maximum computing capability
$${ϕ}_{{n}_{τ i}}^{c} ,$$
a maximum memory capacity
$${ϕ}_{{n}_{τ i}}^{m} ,$$
and a maximum storage capacity
$${ϕ}_{{n}_{τ i}}^{s}$$
of each of server nodes are used to represent computing, memory, and storage resources of the server nodes, respectively, and each of the server nodes belongs to one sub-network; a variable Oₙ_{_{τi}} is defined to represent a domain to which a server node n_{τi}, belongs, a link e_{τi,\hat{τ}j} connects two server nodes n_{τi} and n_{\hat{τ}j}, representing a physical link therebetween; when the network domain τ is equal to \hat{τ}, the physical link connection represents an intra-domain link, and otherwise, the link e_{τi,\hat{τ}j} represents an inter-domain link; nₑ_{_{τi,\hat{τ}j}}_{,1} and nₑ_{_{τi,\hat{τ}j}}_{,2} represent a starting node and an ending node of the link e_{τi,\hat{τ}j}, respectively; and bₑ_{_{τi,\hat{τ}j}} is used to represent a bandwidth capacity of the link e_{τi,\hat{τ}j},
$${\hat{ϕ}}_{{n}_{τ i}}^{c}$$
is used to represent remaining computing resources of the server node n_{τi},
$${\hat{ϕ}}_{{n}_{τ i}}^{m}$$
represents remaining memory resources of the server node n_{τi},
$${\hat{ϕ}}_{{n}_{τ i}}^{s}$$
is used to represent remaining storage resources of the server node n_{τi}, and \hat{b}_{eτi,\hat{τ}j} represents remaining bandwidth resources of the link e_{τi,\hat{τ}j};
(22) constructing the service request model, wherein
all user requests that enter a network function virtualization (NFV)-based multi-domain network and have actual demands are represented as SFC requests, an SFC request set is represented as Γ={Γ₁, Γ₂, . . . , Γᵣ, . . . , Γ_{|Γ|}}, and a 5-tuple {sᵣ, dᵣ, bᵣ, l̅ᵣ, Gᵣ} is defined to represent an SFC request r, wherein sᵣ,dᵣ represent a source node and a target node, respectively, and each SFC request r has a known bandwidth demand bᵣ and a maximum tolerable end-to-end latency requirement l̅ᵣ; and
the SFC request r consists of a group of predefined VNFs and links, wherein the VNFs represent more than one virtualized network function, and is represented as a directed weighted graph Gᵣ={Fᵣ,Eᵣ}, wherein Fᵣ={ƒᵣ₁, ƒᵣ₂, . . . , ƒᵣₕ, . . . , ƒ_{r|F|}} represents a set of VNFs, and Eᵣ={ξ_{ƒrg,ƒrh}|ƒ_{rg},ƒᵣₕ∈Nᵣ} represents a set of virtual network links; and each VNF ƒᵣₕ∈Fᵣ requires a certain amount of server computing resources
$${R}_{{f}_{rh}}^{c}$$
and a certain amount of memory resources
$${R}_{{f}_{rh}}^{m} ,$$
and similarly, bandwidth resources bᵣ need to be allocated for mapping a virtual link;
(23) constructing a VNF-dependent software migration model, configured to migrate software from one server node to another server node, wherein
when the VNF ƒᵣₕ is decided to be deployed on the server node n_{τi} with insufficient software resources, related dependent software of the VNF ƒᵣₕ is migrated to the server node n_{τi}; and Ψ={Ψ₁, Ψ₂, . . . , Ψ_{q}, . . . , Ψ_{|Ψ|}} represents a set of all software resources supporting operation of the VNF ƒᵣₕ; and
for VNF placement and logical link mapping, two binary decision variables are used to define this relationship:
$${x}_{{f}_{rh}}^{{n}_{τ i}} = \{ \begin{matrix}1 , & {f}_{rh} is placed on node {n}_{τ i} , \\ 0 , & otherwise .\end{matrix} \qquad ( 1 )$$
$${y}_{{ξ}_{{f}_{rg} , {f}_{rh}}}^{{e}_{τ i , \hat{τ} j}} = \{ \begin{matrix}1 , & {ξ}_{{f}_{rg} , {f}_{rh}} is mapped on link {e}_{τ i , \hat{τ} j} , \\ 0 , & otherwise .\end{matrix} \qquad ( 2 )$$
wherein a logical link ξ_{ƒrg,ƒrh} is able to be mapped to a plurality of physical links, indicating that communication between VNFs is able to span a plurality of physical connections; and
(24) a VNF-dependent software migration decision
wherein an operating time period of the NFV-based multi-domain network is equally divided into several time slots; it is assumed that new SFC request information is collected in a time slot t−1, an SFC is deployed in a time slot t, and meanwhile, migration of resources of software Ψ_{q} is executed and completed in the time slot t; one binary variable
$${Y}_{{n}_{τ i}}^{{f}_{rh}} ( t )$$
is defined to indicate whether the server node n_{τi} supports the VNF ƒᵣₕ in the time slot t; and
$${χ}_{{ψ}_{q}}^{{n}_{τ i}} ( t )$$
is a binary migration decision variable indicating whether the software Ψ_{q} is migrated for the server node n_{τi} within the time slot t, wherein
$${Y}_{{n}_{τ i}}^{{f}_{rh}} ( t ) = {\prod }_{{ψ}_{q} ∈ {Ψ}_{rh}} {Z}_{{n}_{τ i}}^{{ψ}_{q}} ( t ) \cdot ResourceConstraint , \qquad ( 3 )$$
$${Z}_{{n}_{τ i}}^{{ψ}_{q}} ( t )$$
is a binary variable indicating whether the software Ψ_{q} is on the server node n_{τi} in the time slot t; Ψᵣₕ is a dependent software set supporting operation of the virtual network function ƒᵣₕ; and ResourceConstraint is an indication variable indicating whether other resources on the server node n_{τi} are sufficient to support operation of the VNF ƒᵣₕ, wherein when the resources on the server node n_{τi} are sufficient, a value of the indication variable is 1, and a corresponding mathematical expression is:
$${χ}_{{ψ}_{q}}^{{n}_{τ i}} ( t ) = [ 1 - {Z}_{{n}_{τ i}}^{{ψ}_{q}} ( t - 1 ) ] \cdot [ {Z}_{{n}_{τ i}}^{{ψ}_{q}} ( t - 1 ) ⊕ {Z}_{{n}_{τ i}}^{{ψ}_{q}} ( t ) ] , \qquad ( 4 )$$
wherein when
$${χ}_{{ψ}_{q}}^{{n}_{τ i}} ( t ) ,$$
it indicates that the software Ψ_{q} has been migrated to the server node n_{τi} in the time slot t, and otherwise, it indicates that the software Ψ_{q} has not been migrated;
$${Ψ}_{{f}_{rh}}^{mig}$$
is used to represent a software resource set that needs to be migrated for the VNF ƒᵣₕ; and after software that needs to be migrated is determined, software resources on a corresponding node are updated;
(3) formulating problems to be solved and determining an optimization objective based on the network topology and the service request model constructed in step (2), wherein
the problems to be solved are defined as follows:
an SFC deployment problem, wherein given a domain set [symbol] of a network and an SFC request set Γ, a routing path of an SFC and a deployment policy thereof are determined, and quality of the selected path is considered to minimize an SFC placement cost and ensure an end-to-end latency of the SFC while a constraint of physical network resources is satisfied; and
a VNF-dependent software migration problem, wherein based on the given domain set [symbol] of the network and an SFC deployment result in combination with a distribution matrix Z of current software resources, a migration policy of software and a migration path thereof are determined; and considering a VNF's demand for dependent software, when a selected server node is unable to provide sufficient software resources, a migration cost is minimized; and
an overall optimization objective is determined based on multi-domain network information, user terminal service request information, and the VNF-dependent software migration model, wherein the overall optimization objective is to minimize the end-to-end latency of all SFCs and costs related to SFC deployment and VNF-dependent software, that is, a VNF-dependent software migration cost and a VNF-dependent software placement cost, wherein an end-to-end latency of the SFC request is defined as a sum of link latencies Dᵣ, with a mathematical expression as follows:
$${D}_{r} = {\sum }_{{ξ}_{{f}_{rg} , {f}_{rh}} ∈ {E}_{r}} {\sum }_{{e}_{τ i , \hat{τ} j} ∈ E} {y}_{{}_{{ξ}_{{f}_{rg} , {f}_{rh}}}}^{{}_{{e}_{τ i , \hat{τ} j}}} \cdot {l}_{{e}_{τ i , \hat{τ} j}} + {\sum }_{{f}_{rh} ∈ {F}_{r}} {\sum }_{{n}_{τ i} ∈ N} {x}_{rh}^{{n}_{τ i}} \cdot {l}_{{n}_{τ i}} \qquad ( 5 )$$
wherein l_{eτi,\hat{τ}j} is a latency on the link e_{τi,\hat{τ}j}, and lₙ_{_{τi}} is a processing latency on the server node n_{τi};
a placement cost of the SFC request r is defined as
$${C}_{r}^{d} ,$$
and a total placement cost of the SFC request r is represented by
$${C}_{r}^{s} ,$$
wherein
$${C}_{r}^{d}$$
consists of node resource usage costs, with the following expression:
$${C}_{r}^{d} = {\sum }_{{f}_{rh} ∈ {F}_{r}} {\sum }_{{n}_{τ i} ∈ N} {x}_{{f}_{rh}}^{{n}_{τ i}} \cdot ( {c}_{{n}_{τ i}}^{CPU} \cdot {R}_{{f}_{rh}}^{c} + {c}_{{n}_{τ i}}^{m e m} \cdot {R}_{{f}_{rh}}^{m} ) \qquad ( 6 )$$
and
$$C {r}_{s}^{}$$
consists of the VNF-dependent software migration cost and the VNF-dependent software placement cost, and is defined as follows:
$${C}_{r}^{s} = {\sum }_{{f}_{rh} ∈ {F}_{r}} {\sum }_{{ψ}_{q} ∈ {Ψ}_{{f}_{rh}}^{mig}} {\sum }_{{p}_{τ i , \hat{τ} j} ∈ {L}_{{ψ}_{q}}} {y}_{{p}_{τ i , \hat{τ} j}}^{{e}_{τ i , \hat{τ} j}} \cdot {l}_{{e}_{τ i , \hat{τ} j}} + {\sum }_{{f}_{rh} ∈ {F}_{r}} {\sum }_{{ψ}_{q} ∈ {Ψ}_{{f}_{rh}}^{mig}} {x}_{{f}_{rh}}^{{n}_{τ i}} \cdot {χ}_{{ψ}_{q}}^{{n}_{τ i}} \cdot {c}_{{n}_{τ i}}^{s t o} \cdot {R}_{{ψ}_{q}}^{s} , \qquad ( 7 )$$
a service delivery cost Cᵣ of the SFC request r is defined as follows:
$${C}_{r} = {C}_{r}^{d} + {C}_{r}^{s} , \qquad ( 8 )$$
and a joint optimization objective is expressed as follows:
$$min {\sum }_{{Γ}_{r} ∈ Γ} {ω}_{1} {D}_{r} + {ω}_{2} {C}_{r} \qquad ( 9 )$$
wherein ω₁ and ω₂ are adjustable weight factors for balance each objective; by adjusting a weight factor of each objective, a preference of a specific objective is highlighted, and constraint conditions of physical network resources and quality of service of the SFC are satisfied, wherein
constraint conditions (10) and (11) ensure that on any server node n_{τi}, total central processing unit (CPU) and memory resource demands required for SFC deployment are restricted to respective maximum CPU and memory resource capacities:
$${\sum }_{{Γ}_{r} ∈ Γ} {\sum }_{{f}_{r h} ∈ {F}_{r}} {x}_{{f}_{r h}}^{{n}_{τ i}} \cdot {R}_{{f}_{r h}}^{c} \leq {ϕ}_{{n}_{τ i}}^{c} , ∀ {n}_{τ i} ∈ N , \qquad ( 10 )$$
$${\sum }_{{Γ}_{r} ∈ Γ} {\sum }_{{f}_{r h} ∈ {F}_{r}} {x}_{{f}_{r h}}^{{n}_{τ i}} \cdot {R}_{{f}_{r h}}^{m} \leq {ϕ}_{{n}_{τ i}}^{m} , ∀ {n}_{τ i} ∈ N \qquad ( 11 )$$
a constraint condition (12) ensures that used storage resources shall not exceed a maximum storage resource capacity:
$${\sum }_{{ψ}_{q} ∈ {Ψ}_{{n}_{τ i}}} {Z}_{{n}_{τ i}}^{{ψ}_{q}} \cdot {R}_{{ψ}_{q}}^{S} \leq {ϕ}_{{n}_{τ i}}^{s} , ∀ {n}_{τ i} , ∈ N , \qquad ( 12 )$$
wherein Ψₙ_{_{τi}} is a software set on the server node n_{τi}; and similarly, total bandwidth consumption on any link e_{τi,\hat{τ}j} must be less than a maximum bandwidth capacity, with the following constraint condition:
$${\sum }_{{Γ}_{r} ∈ Γ} {\sum }_{{ξ}_{{f}_{rg}} , {f}_{rh} ∈ {E}_{r}} {y}_{{ξ}_{{f}_{rg}} , {f}_{rh}}^{{e}_{τ i , \hat{τ} j}} \cdot {b}_{r} \leq {b}_{{e}_{τ i , \hat{τ} j}} , ∀ {e}_{τ i , \hat{τ} j} ∈ E . \qquad ( 13 )$$
to satisfy the quality of service, a latency constraint (14) ensures that the end-to-end latency of any SFC request r must be satisfied, with the following constraint condition:
$${D}_{r} \leq \overline{{l}_{r}} , ∀ {Γ}_{r} ∈ Γ \qquad ( 14 )$$
and a constraint (15) ensures that each VNF ƒᵣₕ can be successfully deployed on only one server node at most, which means that a VNF instance is inseparable, and corresponds to:
$${\sum }_{{n}_{τ i} , ∈ N} {x}_{{f}_{r h}}^{{n}_{τ i}} \leq 1 , ∀ {Γ}_{r} ∈ Γ , ∀ {f}_{r h} ∈ {F}_{r} \qquad ( 15 )$$
wherein to simplify SFC deployment, it is assumed that an ingress node of the SFC request r has only one outgoing link, and an egress node has only one incoming link, so as to process a user request; and at any intermediate node on a path selected for the SFC request r, the SFC request r is represented as SFC r in mathematical notation, wherein the SFC r uses only one incoming link and one outgoing link; and if and only if the SFC r uses the link e_{τi,\hat{τ}j}, a variable
$${y}_{r}^{{e}_{τ i , \hat{τ} j}}$$
is equal to 1:
$${\sum }_{{n}_{{e}_{τ i , \hat{τ} j} , 1 = {s}_{r}}} {y}_{r}^{{e}_{τ i , \hat{τ} j}} = 1 , ∀ {Γ}_{r} ∈ Γ , \qquad ( 16 )$$
$${\sum }_{{n}_{{e}_{τ i , \hat{τ} j} , 2 = {t}_{r}}} {y}_{r}^{{e}_{τ i , \hat{τ} j}} = 1 , ∀ {Γ}_{r} ∈ Γ , \qquad ( 17 )$$
$${\sum }_{{n}_{{e}_{τ i , \hat{τ} j} , 1 = n}} {y}_{r}^{{e}_{τ i , \hat{τ} j}} - {\sum }_{{n}_{{e}_{τ i , \hat{τ} j} , 2 = n}} {y}_{r}^{{e}_{τ i , \hat{τ} j}} = 0 , ∀ {Γ}_{r} ∈ Γ , ∀ n ∈ N \neq {s}_{r} , {t}_{r} ; \qquad ( 18 )$$
and (4) designing a layered architecture and a deployment and migration mechanism, wherein a multi-layer network architecture is adopted, each VNF corresponds to an independent layer of network, a matching relationship between each VNF and all nodes is calculated based on an analytic hierarchy process, and a multi-layer network weighted graph is constructed, wherein a shortest path for deploying an SFC and a placement node of the VNF are determined from the multi-layer weighted graph based on a dynamic programming algorithm, and a migration policy of the VNF-dependent software is determined after the placement node of the VNF is obtained.

2. The method for SFC deployment according to claim 1, wherein in the method, the terminal user initiates extreme service request information to the domain-specific SDN controller; the domain-specific SDN controller transmits the information to the central SDN controller; and the central SDN controller decides that the multi-domain network provides a deployment location and the migration policy of the VNF-dependent software for the service function chain in conjunction with the method for SFC deployment based on VNF-dependent software migration, thereby reducing an end-to-end communication latency and resource usage cost of a service, and a VNF-dependent software resource usage cost and the VNF-dependent software migration cost, and ensuring load balancing of the multi-domain network.

3. The method for SFC deployment according to claim 1, wherein when the network topology and the service request model constructed in step (2) are used to implement SFC deployment, VNF instantiation not only depends on a virtualization technology, but also needs to fully consider software resource adaptability of a physical node, comprising considering network attributes such as a capability of computing nodes, and a bandwidth and latency of a link in a multi-domain network implemented based on the network topology, and describing intra-domain and inter-domain communication topologies by using a graph model; defining a plurality of service request types, extracting key indicators of network attributes thereof, and simulating dynamicity of request arrivals by using a random process; and determining a VNF-dependent software migration model based on two established models.

4. The method for SFC deployment according to claim 1, wherein the layered architecture design and the deployment and migration mechanism in step (4) are specifically as follows:
(41) algorithm initialization, wherein
a multi-layer network structure is constructed, wherein each VNF corresponds to an independent layer and is used to calculate a matching relationship between each VNF and all nodes; and
a multi-dimensional resource indicator is introduced, wherein in an initialization phase, a network graph MGᵣₕ is generated for each VNF in the SFC; and independent network graphs MGᵣₕ are connected to each other through corresponding nodes, thereby constructing a multi-layer network graph MGᵣ with a number of layers being |F_{τ}|;
(42) AHP-based performance metrics, wherein
first, data of each layer of physical nodes is extracted from the multi-layer network graph MGᵣ, comprising remaining computing, memory, and storage resources, software resources, and processing latencies; next, a pair-wise comparison matrix NCM is constructed for evaluating a criterion layer for a target; then, to compare pairing relationships of same-type elements of all nodes in the multi-layer network graph MGᵣₕ, eight |N|×|N| matrices are constructed, and are named computing resource utilization
$$N C {M}_{r h}^{c u} ,$$
memory resource utilization
$$N C {M}_{r h}^{m u} ,$$
storage resource utilization
$$NC {M}_{r h}^{s u} ,$$
storage resource usage cost
$$N C {M}_{r h}^{s m} ,$$
reciprocal of remaining computing resources
$${NCM}_{r h}^{irc} ,$$
reciprocal of remaining memory resources
$${NCM}_{r h}^{irm} ,$$
reciprocal of remaining storage resources
$${NCM}_{rh}^{irs} ,$$
and processing latency
$$N C {M}_{r h}^{p d} ,$$
respectively, and a consistency test is performed on the matrices, wherein
a consistency ratio is used for evaluating consistency of the pair-wise comparison matrix, and a consistency index CI is defined as
$$CI = \frac{{λ}_{max} - \vert N \vert}{\vert N \vert - 1}$$
and used for quantifying and determining a degree of consistency in the matrix, wherein λₘₐₓ represents a maximum eigenvalue of the pair-wise comparison matrix;
a random consistency index RI depends on dimensions of the matrix and is obtained from a known RI value table;
if the pair-wise comparison matrix satisfies a consistency standard, an eigenvector corresponding to the maximum eigenvalue is extracted; otherwise, the pair-wise comparison matrix is reconstructed; and then an indicator value of h_{τi} is calculated; and
a link indicator is calculated by using a similar method, wherein an indicator value of an inter-layer link is set to 0 all the time; and through the foregoing iterative process, a multi-layer weighted network is finally generated and denoted as MWGᵣ; and
(43) SFC deployment and VNF-dependent software migration policies, wherein after a multi-layer weighted graph MWGᵣ is obtained, a next task is to determine a communication path from the source node to the target node and a node for placing the VNF, which is specifically as follows:
first, a starting node is mapped to a node label in MWGᵣ; for each layer, one placement node is selected for the VNF, and metrics of an intra-layer link and an inter-layer communication link are calculated; then comprehensive metrics of the selected placement server node and links are calculated; and finally, the selected deployment server node and communication link are returned; and
a potential software migration scenario is considered during calculation of the metric of the server node, such that an optimal migration policy is selected based on VNF placement.
